(19) United States
(12) Patent Application Publication
(10) Pub. No.: US 2003/0135442 A1
(43) Pub. Date: Jul. 17, 2003

(54) Method and apparatus for determining an offer regarding a financial product

(76) Inventors: Neeraj Kumar, Bangalore (IN); Shrikant Dash, Bangalore (IN); Muthu Kumar, Bangalore (IN)

Correspondence Address: BUCKLEY, MASCHOFF, TALWALKAR, & ALLISON, 5 ELM STREET, NEW CANAAN, CT, 06840, US

(21) Appl. No.: 10/036,172

(22) Filed: Dec. 31, 2001

(51) Int. Cl. G06F 17/60

(52) U.S. Cl. 705/37

(57) ABSTRACT

A system, method, apparatus, means, and computer program code for efficiently promoting use of a financial product (e.g., credit card). According to embodiments of the present invention, an entity may have multiple offers that the entity can make regarding a financial product, each of which may product different results, have different costs, or satisfy different entity requirement(s) or objective(s). Prior to making an offer regarding the financial product, the entity may determine which one or more of the available offers complies with or best meets the requirement(s) or objective(s) and conduct a promotional campaign in accordance with the identified offer(s).

### CROSS-REFERENCE TO RELATED INVENTION

This patent application is related to co-pending U.S. patent application entitled Method and Apparatus for Promoting Use of a Financial Product, patent application Ser. No. ______(Attorney Docket Number G07-010), filed simultaneously herewith, the contents of which are incorporated herein by reference.

### FIELD OF THE INVENTION

The present invention relates to a method and apparatus for determining an offer to make to one or more recipients of a communication regarding a financial product and, more particularly, embodiments of the present invention relate to methods, means, apparatus, and computer program code for determining which one or more of a plurality of potential offers best meets one or more requirements associated with a promotional communication.

### BACKGROUND OF THE INVENTION

A seller or provider of a financial product typically wants holders of the financial product to increase use of the financial product. For example, an issuer of a credit card may make money from merchants from each transaction made by a customer with the merchants using the credit card. In addition, the issuer may be able to charge interest to the customer if the customer maintains a balance due with the credit card. In order to increase the use of issued credit cards by customers, the issuer may send out promotional communications (e.g., advertisements, letters) offering special deals, reminding customers of the benefits of their credit card, etc. Due to the labor, financial, and other costs associated with providing promotional communications to customers, the issuer may want to target the promotional communications to the most receptive customers, i.e., those customers who are most likely to increase their level of use of the credit card as a result of receiving the promotional communication. The issuer may have a variety of offers that can be made to customers, each having different costs and expected results.

It would be advantageous to provide a method, means, computer code and apparatus that allowed an entity providing a financial product to identify from among multiple available offers the offer(s) that best comply with or satisfy a requirement or objective that the entity may have.

### SUMMARY OF THE INVENTION

Embodiments of the present invention provide a system, method, apparatus, means, and computer program code for allowing an entity to select one or more offers regarding a financial product to provide to one or more recipients via a promotional communication. A promotional communication may be included in or form part of a promotional campaign regarding the financial product. In some embodiments, an offer may be selected such that obtains the best results while meeting one or more objectives or requirements associated with the promotional communication or campaign For example, an entity sending a promotional communication to a group or segment of recipients may want the recipients to increase their level of use of a credit card. The promotional communication may be sent as part of a marketing or promotional campaign for the credit card. Different communications, offers, etc. may be used for different financial products, campaigns, or groups or segments of potential recipients, etc. In addition, different communications may make different offers to recipients of the communications regarding one or more financial products.

A financial product may include a credit card or debit card issued by a bank or other entity. In some embodiments, a financial product may be a credit card or debit card branded or private labeled with a logo of a merchant, advertiser, sports organization, bank or other financial institution, etc. The term “product” as used herein shall also include services that may be provided by the manager or other entity to potential and/or actual recipients of communications.

An entity deciding to promote a financial product may have many different types of offers to choose from. For example, an offer may provide a ten percent discount on all purchases made via a credit card, a ten percent discount on all purchases made during a specific time period, a ten percent discount on all purchases made at a specific merchant, an opportunity to renew a credit card, an opportunity to receive a new credit card, etc.

As any promotional communication or campaign has associated labor, time, and financial costs, the entity may want to meet one or more designated objectives or requirements when selecting an offer to make. For example, the entity may want to receive the maximum number of respondents to a promotional communication for a designated cost. As another example, the entity may want to receive the maximum number of respondents to a promotional communication for a designated maximum number of recipients of the promotional communication.

Prior to sending a new promotional communication regarding a financial product, an entity may receive information regarding past responses or activities by recipients of one or more prior promotional communications or offers. From this and other data regarding the recipients, offers, campaign requirements or other objectives, a decision can be made regarding which offer to provide to which recipient, which may be made via a promotional communication.

A promotional communication may be or include any type of advertising, promotional or marketing material, message, etc. The communication may comprise, be sent in, or be part of an email message, instant message communication, banner or other electronic or Web based advertisement, letter, postcard, flyer, document, paper, coupon, facsimile transmission, beeper or pager signal or transmission, HTTP, FTP, XML or HTML transmission or feed, some other electronic signal or communication, etc.

Additional objects, advantages, and novel features of the invention shall be set forth in part in the description that follows, and in part will become apparent to those skilled in the art upon examination of the following or may be learned by the practice of the invention.

According to embodiments of the present invention, a method for selecting at least one offer regarding a financial product may include determining a plurality of offers regarding a financial product available for a campaign; determining at least one of the plurality of offers that complies with a requirement associated with the campaign; determining a plurality of recipients associated with the determined at least one of the plurality of offers; and providing the determined at least one of the plurality of offers to at least one of the plurality of recipients. In another embodiment, a method for selecting at least one offer regarding a financial product to make to a recipient may include determining, for each offer of a plurality of potential offers regarding a financial product, a plurality of segments of potential recipients of the offer, wherein each segment for an offer has an associated response rate indicative of a member of the segment completing a designated action associated with the segment after receiving the offer; determining at least one objective associated with a campaign, wherein the campaign will include at least one of the plurality of potential offers; determining at least one offer from the plurality of offers that complies with the at least one objective; and providing a notification indicative of at least one member of at least one segment of potential recipients associated with the determined at least one offer. In a further embodiment, a method for selecting at least one offer regarding a financial product to provide to a recipient may include determining a first plurality of segments of potential recipients of a first offer, wherein each of the first plurality of segments has an associated response rate, and wherein a segment's associated response rate is indicative of a member of the segment completing a designated action associated with the segment after receiving the first offer; determining a second plurality of segments of potential recipients of a second offer, wherein each of the second plurality of segments has an associated response rate, and wherein a segment's associated response rate is indicative of a member of the segment completing a designated action associated with the segment after receiving the second offer; determining at least one objective associated with a campaign regarding the financial product; and providing either the first offer to at least one member of at least one segment from the first plurality of segments if the first offer meets the at least one objective better than the second offer, or the second offer to at least one member of at least one segment from the second plurality of segments if the second offer meets the at least one objective better than the first offer. In yet another embodiment, a method for determining an offer regarding a financial product to provide to a recipient may include determining a plurality of potential offers for a campaign regarding a financial product, the campaign having at least one associated requirement and at least one designated action; determining, for each offer from the plurality of potential offers, a plurality of segments of potential recipients of the offer, wherein each segment from the plurality of segments has an associated characteristic, the characteristic being indicative of a member of the segment completing the designated action after receiving the offer; determining which offer from the plurality of offers best complies with the at least one requirement; and providing the determined offer to at least one member of a segment of the plurality of segments associated with the determined offer. In still another embodiment, a method for determining an offer regarding a financial product may include determining, for each offer of a plurality of potential offers regarding a financial product, a plurality of segments of potential recipients of the offer, wherein each segment for an offer has an associated response rate indicative of a member of the segment completing a designated action associated with the segment after receiving the offer; determining at least one objective associated with a campaign, wherein the campaign will include at least one of the plurality of potential offers; determining a score for at least one of a the plurality of offers, the score being indicative of the at least one offer compliance with the at least one objective; and providing a notification indicative of the score.

According to embodiments of the present invention, a system for determining at least one offer regarding a financial product may include a memory; a communication port; and a processor connected to the memory and the communication port, the processor being operative to determine a plurality of offers regarding a financial product available for a campaign; determine at least one of the plurality of offers that complies with a requirement associated with the campaign; determine a plurality of recipients associated with the determined at least one of the plurality of offers; and provide the determined at least one of the plurality of offers to at least one of the plurality of recipients. In another embodiment, a system for selecting at least one offer regarding a financial product to make to a recipient may include a memory; a communication port; and a processor connected to the memory and the communication port, the processor being operative to determine for each offer of a plurality of potential offers regarding a financial product, a plurality of segments of potential recipients of the at least one offer, wherein each segment for an offer has an associated response rate indicative of a member of the segment completing a designated action associated with the segment after receiving the offer; determine at least one objective associated with a campaign, wherein the campaign will include at least one of the plurality of potential offers; determine at least one offer from the plurality of offers that complies with the at least one objective; and provide a notification indicative of at least one member of at least one segment of potential recipients associated with the at least one determined offer. In a further embodiment, a system for selecting at least one offer regarding a financial product to provide to a recipient may include a memory; a communication port; and a processor connected to the memory and the communication port, the processor being operative to determine a first plurality of segments of potential recipients of a first offer, wherein each of the first plurality of segments has an associated response rate, and wherein a segment's associated response rate is indicative of a member of the segment completing a designated action associated with the segment after receiving the first offer; determine a second plurality of segments of potential recipients of a second offer, wherein each of the second plurality of segments has an associated response rate, and wherein a segment's associated response rate is indicative of a member of the segment completing a designated action associated with the segment after receiving the second offer; determine at least one objective associated with a campaign regarding the financial product; and provide either the first offer to at least one member of at least one segment from the first plurality of segments if the first offer meets the at least one objective better than the second offer, or the second offer to at least one member of at least one segment from the second plurality of segments if the second offer meets the at least one objective better than the first offer. In yet another embodiment, a system for determining an offer regarding a financial product to provide to a recipient may include a memory; a communication port; and a processor connected to the memory and the communication port, the processor being operative to determine a plurality of potential offers for a campaign regarding a financial product, the campaign having at least one associated requirement and at least one designated action; determine, for each offer from the plurality of potential offers, a plurality of segments of potential recipients of the offer, wherein each segment from the plurality of segments has an associated characteristic, the characteristic being indicative of a member of the segment completing the designated action after receiving the offer; determine which offer from the plurality of offers best complies with the at least one requirement; and provide the determined offer to at least one member of a segment of the plurality of segments associated with the determined offer. In still another embodiment, a system for determining an offer regarding a financial product may include a memory; a communication port; and a processor connected to the memory and the communication port, the processor being operative to determine, for each offer of a plurality of potential offers regarding a financial product, a plurality of segments of potential recipients of the offer, wherein each segment for an offer has an associated response rate indicative of a member of the segment completing a designated action associated with the segment after receiving the offer; determine at least one objective associated with a campaign, wherein the campaign will include at least one of the plurality of potential offers; determine a score for at least one of a the plurality of offers, the score being indicative of the at least one offer compliance with the at least one objective; and provide a notification indicative of the score.

According to embodiments of the present invention, a computer program product in a computer readable medium for determining at least one offer regarding a financial product may include first instructions for identifying a plurality of offers regarding a financial product available for a campaign; second instructions for identifying at least one of the plurality of offers that complies with a requirement associated with the campaign; third instructions for identifying a plurality of recipients associated with the determined at least one of the plurality of offers; and fourth instructions for sending a communication regarding the determined at least one of the plurality of offers to at least one of the plurality of recipients. In another embodiment, a computer program product in a computer readable medium for selecting at least one offer regarding a financial product to make to a recipient may include first instructions for identifying, for each offer of a plurality of potential offers regarding a financial product, a plurality of segments of potential recipients of the offer, wherein each segment for an offer has an associated response rate indicative of a member of the segment completing a designated action associated with the segment after receiving the offer; second instructions for identifying at least one objective associated with a campaign, wherein the campaign will include at least one of the plurality of potential offers; third instructions for identifying at least one offer from the plurality of offers that complies with the at least one objective; and fourth instructions for sending a notification indicative of at least one member of at least one segment of potential recipients associated with the at least one determined offer. In a further embodiment, a computer program product in a computer readable medium for selecting at least one offer regarding a financial product to provide to a recipient may include first instructions for identifying a first plurality of segments of potential recipients of a first offer, wherein each of the first plurality of segments has an associated response rate, and wherein a segment's associated response rate is indicative of a member of the segment completing a designated action associated with the segment after receiving the first offer; second instructions for identifying a second plurality of segments of potential recipients of a second offer, wherein each of the second plurality of segments has an associated response rate, and wherein a segment's associated response rate is indicative of a member of the segment completing a designated action associated with the segment after receiving the second offer; third instructions for identifying at least one objective associated with a campaign regarding the financial product; and fourth instructions for sending either the first offer to at least one member of at least one segment from the first plurality of segments if the first offer meets the at least one objective better than the second offer, or the second offer to at least one member of at least one segment from the second plurality of segments if the second offer meets the at least one objective better than the first offer. In yet another embodiment, a computer program product in a computer readable medium for determining an offer regarding a financial product to provide to a recipient may include first instructions for identifying determining a plurality of potential offers for a campaign regarding a financial product, the campaign having at least one associated requirement and at least one designated action; second instructions for identifying, for each offer from the plurality of potential offers, a plurality of segments of potential recipients of the offer, wherein each segment from the plurality of segments has an associated characteristic, the characteristic being indicative of a member of the segment completing the designated action after receiving the offer; third instructions for identifying which offer from the plurality of offers best complies with the at least one requirement; and fourth instructions for sending the determined offer to at least one member of a segment of the plurality of segments associated with the determined offer. In still another embodiment, a computer program product in a computer readable medium for determining an offer regarding a financial product may include first instructions for identifying, for each offer of a plurality of potential offers regarding a financial product, a plurality of segments of potential recipients of the offer, wherein each segment for an offer has an associated response rate indicative of a member of the segment completing a designated action associated with the segment after receiving the offer; second instructions for identifying at least one objective associated with a campaign, wherein the campaign will include at least one of the plurality of potential offers; third instructions for identifying a score for at least one of a the plurality of offers, the score being indicative of the at least one offer compliance with the at least one objective; and fourth instructions for sending a notification indicative of the score.

According to embodiments of the present invention, an apparatus for determining at least one offer regarding a financial product may include means for identifying a plurality of offers regarding a financial product available for a campaign; means for identifying at least one of the plurality of offers that complies with a requirement associated with the campaign; means for identifying a plurality of recipients associated with the determined at least one of the plurality of offers; and means for sending a communication regarding the determined at least one of the plurality of offers to at least one of the plurality of recipients. In another embodiment, an apparatus for selecting at least one offer regarding a financial product to make to a recipient may include means for identifying, for each offer of a plurality of potential offers regarding a financial product, a plurality of segments of potential recipients of the offer, wherein each segment for an offer has an associated response rate indicative of a member of the segment completing a designated action associated with the segment after receiving the offer; means for identifying at least one objective associated with a campaign, wherein the campaign will include at least one of the plurality of potential offers; means for identifying at least one offer from the plurality of offers that complies with the at least one objective; and means for sending a notification indicative of at least one member of at least one segment of potential recipients associated with the at least one determined offer. In a further embodiment, an apparatus for selecting at least one offer regarding a financial product to provide to a recipient may include means for identifying a first plurality of segments of potential recipients of a first offer, wherein each of the first plurality of segments has an associated response rate, and wherein a segment's associated response rate is indicative of a member of the segment completing a designated action associated with the segment after receiving the first offer; means for identifying a second plurality of segments of potential recipients of a second offer, wherein each of the second plurality of segments has an associated response rate, and wherein a segment's associated response rate is indicative of a member of the segment completing a designated action associated with the segment after receiving the second offer; means for identifying at least one objective associated with a campaign regarding the financial product; and means for sending either the first offer to at least one member of at least one segment from the first plurality of segments if the first offer meets the at least one objective better than the second offer, or the second offer to at least one member of at least one segment from the second plurality of segments if the second offer meets the at least one objective better than the first offer. In yet another embodiment, an apparatus for determining an offer regarding a financial product to provide to a recipient may include means for identifying determining a plurality of potential offers for a campaign regarding a financial product, the campaign having at least one associated requirement and at least one designated action; means for identifying, for each offer from the plurality of potential offers, a plurality of segments of potential recipients of the offer, wherein each segment from the plurality of segments has an associated characteristic, the characteristic being indicative of a member of the segment completing the designated action after receiving the offer; means for identifying which offer from the plurality of offers best complies with the at least one requirement; and means for sending the determined offer to at least one member of a segment of the plurality of segments associated with the determined offer. In still another embodiment, an apparatus for determining an offer regarding a financial product may include means for identifying, for each offer of a plurality of potential offers regarding a financial product, a plurality of segments of potential recipients of the offer, wherein each segment for an offer has an associated response rate indicative of a member of the segment completing a designated action associated with the segment after receiving the offer; means for identifying at least one objective associated with a campaign, wherein the campaign will include at least one of the plurality of potential offers; means for identifying a score for at least one of a the plurality of offers, the score being indicative of the at least one offer compliance with the at least one objective; and means for sending a notification indicative of the score.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

The accompanying drawings, which are incorporated in and form a part of the specification, illustrate the preferred embodiments of the present invention, and together with the descriptions serve to explain the principles of the invention.

FIG. 1 is a flowchart of a first embodiment of a method in accordance with the present invention;

FIG. 2 is a flowchart of a second embodiment of a method in accordance with the present invention;

FIG. 3 is a block diagram of system components for an embodiment of an apparatus usable with the methods of FIGS. 1-2;

FIG. 4 is a block diagram of components for an embodiment of a manager device of FIG. 3;

FIG. 5 is an illustration of a representative recipient information database of FIG. 4;

FIG. 6 is an illustration of a representative recipient device information database of FIG. 4;

FIG. 7 is an illustration of a representative segment information database of FIG. 4;

FIG. 8 is an illustration of a representative offer information database of FIG. 4;

FIG. 9 is an illustration of a representative financial product information database usable with the manager device of FIG. 4; and

FIG. 10 is an illustration of a representative account information database usable with the manager device of FIG. 4.

### DETAILED DESCRIPTION

Applicants have recognized that there is a need for systems, means, computer code and methods that allow an entity to select an offer regarding a financial product to provide to one or more recipients via a promotional communication. A promotional communication may be included in or form part of a promotional campaign regarding the financial product. In some embodiments, an offer may be selected such that obtains the best results while meeting one or more objectives or requirements associated with the promotional communication or campaign

An offer may be sent as part of a marketing or promotional campaign for a financial product. For example, a merchant may want to promote use of a merchant branded or private labeled credit card for purchases made by recipients of a communication regarding the credit card at the merchant. Different offers may be used for different financial products. In addition, different offers may make different offers to recipients of the offers regarding one or more financial products. For example, an entity providing an offer or other promotional communication to a group or segment of recipients may want the recipients to increase their level of use of a credit card. The offer may be sent as part of a marketing or promotional campaign for the credit card. Different communications, offers, etc. may be used for different financial products, campaigns, groups or segments of potential recipients, etc. In addition, different communications may make different offers to recipients of the communications regarding one or more financial products. A technical effect provided by the systems, means, computer code and methods described herein is that potential offers can best be matched against desired requirements or other objectives for a promotional campaign.

For purposes of discussion of the methods disclosed herein, the methods will be assumed to be conducted by an entity referred to herein as a “manager” and/or a device referred to herein as a “manager device”. The term “manager” is not intended to have any specific or limited meaning. In such embodiments, the manager may use the methods disclosed herein to determine which type, format, etc. of offer best motivates recipients to complete a desired or designated action or behavior and complies with a requirement or objective associated with a promotional campaign. For example, the designated activity may be a recipient signing up to apply for, use or receive a credit card; the recipient using a previously issued credit card; the recipient getting someone else to agree to use, apply for, or accept a credit card; the recipient agreeing to use a specific debit card or bank account; etc. In some embodiments, the desired or designated activity may include a recipient of an offer regarding a financial product to use the financial product in making purchases or conducting other transactions over and above the level of use the recipient would have made of the financial product if the recipient had not received the offer. More specially, the desired action or behavior in a recipient receiving an offer may be incremental use of a credit card after the recipient receives the credit card.

In some embodiments, a financial product may be or include a credit card, debit card or other financial card issued by or for the manager, or by or for one or more other entities by the manager. In some cases, the manager may provide services to other entities selling or servicing financial products, even though the manager itself does not provide or service the financial products. In some embodiments, a financial product may include a credit card or debit card branded or private labeled with a logo of a merchant, advertiser, sports organization, bank or other financial institution, etc. The term “product” as used herein shall also include services that may be provided by the manager or other entity to potential and/or actual recipients of communications.

These and other features will be discussed in further detail below, by describing a system, individual devices, computer code, and processes according to embodiments of the invention.

Process Description

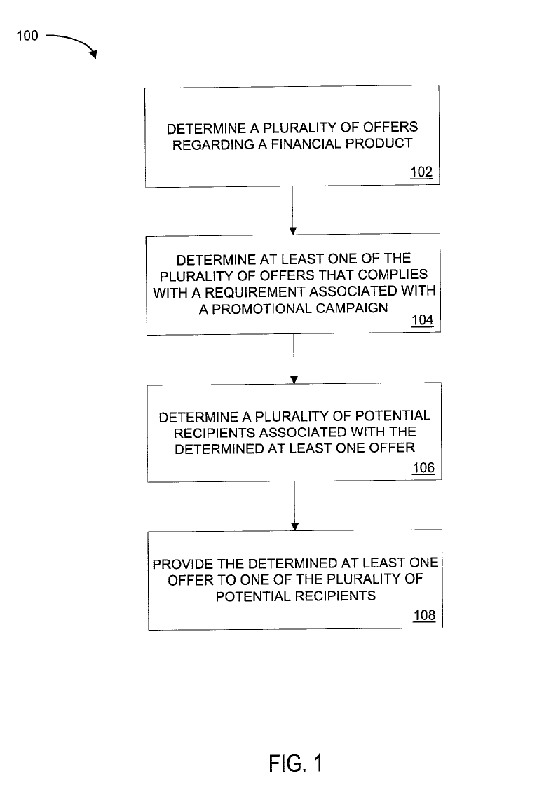

Reference is now made to FIG. 1, where a flow chart 100 is shown which represents the operation of a first embodiment of the present invention. The particular arrangement of elements in the flow chart 100 is not meant to imply a fixed order to the steps; embodiments of the present invention can be practiced in any order that is practicable. In some embodiments, some or all of the steps of the method 100 may be performed or completed by a manager, server, and/or another entity or device for itself or on behalf of one or more parties, as will be discussed in more detail below. For purposes of discussion, but not limitation, of the method 100, the method 100 is assumed to be conducted by a “manager” and/or a “manager device” on behalf of itself and/or one or more other entities.

Processing begins at a step 102 during which the manager determines a plurality of potential or available offers regarding a financial product. Potential offers may include offers for discounts, rebates, etc. on purchases made at a specific merchant, offers for discounts, rebates, etc. on purchases made using a specific financial product, offers for discounts, rebates, etc. on purchases made during a specific time period, etc. Discounts may be or include designated numerical discounts (e.g., ten dollars) or percentage discounts (e.g., ten percent off the value of purchases). In some embodiments, an offer may include an offer to reissue a financial product, adjust temporarily of permanently a term or condition (e.g., interest percentage, delayed payment penalty) associated with a financial product, etc.

In some embodiments, prior to or as part of the step 102, the manager may need to identify select some or all of the plurality of recipients. The manager may keep lists or descriptions of potential offers, purchase lists or descriptions of potential offers, receive lists or descriptions of potential offers, etc. For example, a credit card issuer may want the manager to help the credit card issuer determine what offer to make in a promotional communication regarding a credit card. The credit card issuer may provide to the manager a list or other data indicative of the offers available for use, or request that the manager use one or more of a designated or selected set of offers. In some embodiments, information regarding one or more offers may be stored in or accessed from an offer information database.

In some embodiments, the step 102 or the method 100 may include determining for different offers how one or more potential recipients of the offers may respond to the offers. For example, offers may be categorized according to how potential recipients respond are expected to respond to the offers. Alternatively, offers may be categorized according to how potential recipients are expected to complete or otherwise exhibit a desired action or behavior upon receiving the offer.

A desired or designated recipient action, behavior or goal may be associated with a new communication regarding the financial product. For example, an offer, or a communication that includes the offer, may be designed to promote use of a credit card by a recipient. The desired action may be transactions or purchases made by the recipient using the credit card in response to the offer or communication over and above what the recipient would have done without receiving the offer or communication (e.g., an incremental purchase or transaction). The manager or some other entity or device may determine which recipients that received the offer or communication completed or satisfied the desired action. This might be done by comparing uses of credit cards by recipients of the offer or communication to uses of credit cards by people who did not receive the offer or communication (i.e., a control group or segment). From this group of recipients of the offer or communication that completed the desired action, segments of the recipients may be created and a response rate to the offer or communication determined for each segment The manager may use the information to determine offers during the step 102. Additional information regarding potential segmentation or identification of potential recipients for one or more offers is provided below and can be found in the co-pending U.S. patent application entitled Method and Apparatus for Promoting Use of a Financial Product, filed simultaneously herewith and the contents of which are incorporated herein by reference.

During a step 104, at least one of the plurality of offers is selected that best satisfies or otherwise complies with a requirement or objective associated with a promotional campaign that will include the offer. For example, an entity conducting or requesting a promotional campaign may want promotional communications or campaigns containing the identified offer to be mailed to a maximum number of recipients, to be mailed to a maximum percentage of all of the potential recipients, etc. As another potential requirement, the entity may have a maximum amount the entity can spend on the campaign. As another example, the entity may want to receive a minimum or lower threshold number of respondents to an offer (e.g., recipients who complete a designated action associated with the campaign after receiving the offer) for the least cost, a minimum number or lower threshold number of respondents to an offer as a percentage of all recipients of the offer, etc. As a further example, the entity may establish a minimum return on investment (ROI), a minimum gross marketing return (GMR), maximum risk, a minimum propensity of response, a maximum number of recipients of a communication containing the offer, a minimum incremental sales result, etc. that the offer determined during the step 104 preferably will meet, provide or satisfy (i.e., comply with), a maximum allowed cost for discounts provided, a maximum allowed mailing cost for offers or communications containing the offers, a maximum allowed total campaign cost, etc. In some embodiments, information regarding one or more offers may be stored in, or access from, an offer information database. In some embodiments, the step 104 may result in several offers being determined.

As one example of how one or more offers may be determined during the step 104, suppose two types of offers have been made in the past to different segments or groups of recipients. Offer A offered a reissue of a merchant's credit card (i.e., an offer for a new or replacement credit card for an existing customer) to recipients. Offer B offer a reissue of a merchant's credit card plus ten percent off purchases at the merchant made using the credit card during a one month period. Incremental sales may by recipients of the offers as well as the costs of the offers, the return on investment (ROI) created by the offers, and the gross marketing return (GMR) created by the offers are illustrated in Table 1 below. Gross marketing return (GMR) refers to the total incremental sales received from making one or more offers divided by the total cost of the offers. A gross marketing return of ten for an offer/segment combination means that incremental sales produced by the combination is equal to ten times the total cost for the combination.

TABLE 1

| | | Average | | | | | | | | | |
|---|---|---|---|---|---|---|---|---|---|---|---|
| | | Inc. Sales | | Offer | | | | | | | |
| | | per Rec. | | A | | | | | | | |
| | | Obtained as | | Costs | | | | | | | |
| | Number | a Result | | per | Offer B Costs | | | | | | |
| | of Rec. | of Offer | | Rec. | per Recipient | | | ROI | | GMR | |
| | in | Offer | Offer | Mail | Mail | Disc | | | Offer | Off. | Off. |
| Segment | Segment | A | B | Cost | Cost | Cost | Total | Offer A | B | A | B |
| New | 14,250 | −$6 | $28 | $0.6 | $0.6 | $3.3 | $3.9 | −288% | 30% | −10 | 7 |
| Home | | | | | | | | | | | |
| Equity | | | | | | | | | | | |
| New | 42,775 | $18 | −$5 | $0.6 | $0.6 | $2.9 | $3.5 | 451% | −124% | 31 | −1 |
| Mortgage | | | | | | | | | | | |
| Mortgage | 28,650 | $25 | $99 | $0.6 | $0.6 | $2.8 | $3.4 | 647% | 425% | 42 | 29 |
| Inquiry | | | | | | | | | | | |
| New | 30,175 | −$25 | −$67 | $0.6 | $0.6 | $2.3 | $2.9 | −838% | −516% | −41 | −23 |
| Mover | | | | | | | | | | | |
| LPD 0-6 | 496,250 | $31 | $66 | $0.6 | $0.6 | $6.2 | $6.8 | 817% | 76% | 51 | 10 |
| Mth High | | | | | | | | | | | |
| LPD 0-6 | 477,475 | $6 | $66 | $0.6 | $0.6 | $4.5 | $5.1 | 90% | 133% | 11 | 13 |
| Mth | | | | | | | | | | | |
| Medium | | | | | | | | | | | |
| LPD 0-6 | 651,825 | $2 | $27 | $0.6 | $0.6 | $3.2 | $3.8 | −48% | 31% | 3 | 7 |
| Mth Low | | | | | | | | | | | |
| LPD 7-12 | 88,700 | $10 | $61 | $0.6 | $0.6 | $3.5 | $4.1 | 204% | 165% | 17 | 15 |
| Mth High | | | | | | | | | | | |
| LPD 7 12 | 78,300 | $11 | $48 | $0.6 | $0.6 | $2.2 | $2.8 | 238% | 214% | 19 | 17 |
| Mth | | | | | | | | | | | |
| Medium | | | | | | | | | | | |
| LPD 7-12 | 248,375 | $23 | $23 | $0.6 | $0.6 | $2.3 | $2.9 | 588% | 40% | 38 | 8 |
| Mth Low | | | | | | | | | | | |
| Inactive | 343,225 | $16 | $62 | $0.6 | $0.6 | $2.4 | $3.0 | 373% | 266% | 26 | 20 |
| Total | 2,500,000 | | | | | | | | | | |

The segment labeled “New Home Equity” includes recipients who recently (e.g., within the last six months) took a home equity loan. The segment labeled “New Mortgage” includes recipients who recently took a mortgage loan. The segment labeled “Mortgage Inquiry” includes recipients who recently made an inquiry regarding a mortgage loan. The segment labeled “New Mover” includes recipients who recently moved. The segment labeled “LPD 0-6 Mth High” includes recipients whose last purchase on or using a merchant's credit card was within the past six months and who belong to a high spender category. The term “LPD” stands for last purchase date. The segment labeled “LPD 0-6 Mth Medium” includes recipients whose last purchase on or using a merchant's credit card was within the past six months and who belong to a medium spender category. The segment labeled “LPD 0-6 Mth Low” includes recipients whose last purchase on or using a merchant's credit card was within the past six months and who belong to a low spender category. The segment labeled “LPD 7-12 Mth High” includes recipients whose last purchase on or using a merchant's credit card was within seven to twelve months and who belong to a high spender category. The segment labeled “LPD 7-12 Mth Medium” includes recipients whose last purchase on or using a merchant's credit card was within seven to twelve months and who belong to a medium spender category. The segment labeled “LPD 7-12 Mth Low” includes recipients whose last purchase on or using a merchant's credit card was within seven to twelve months and who belong to a low spender category. The segment labeled “Inactive” includes recipients who have not made any purchases on or using the merchant's credit card in the past twelve months. A low spender may be defined as a person who has spent, or on average spends, less than a first designated or lower threshold amount (e.g., one hundred dollars, five hundred dollars) during a designated time period (e.g., month, year, quarter). A medium spender may be defined as a person who has spent, or on average spends, more than the first designated or threshold amount and less than a second designated or threshold amount (e.g., five hundred dollars, one thousand dollars) during the time period. Similarly, a high spender may be defined as a person who has spent, or who on average spends, more than the second designated or threshold amount during the time period. Different thresholds or designated amounts, as well as different time periods, may be used for different offers, campaigns, promotional communications, etc. For the example illustrated in Table 1, the low spender category includes peoples who spend between one dollar and $245 per year using a merchant's credit card, the medium spender category includes people who spend between $246 and $559 per year using the merchant's credit card, and the high spender category includes people who spend $560 or more per year using the merchant's credit card. Some or all of the information illustrated in Table 1 may be stored in, or accessed from, a recipient information database, a segment information database, an offer information database, etc.

An entity desiring to make one or more new offers may want to maximize the incremental sales made by recipients of the new offer(s) while constraining or limiting the selection or recipients. For example, the entity may make one or more of the following constraints: (1) imposing an upper bound on the number of recipients selected from each segment to receive the new offer(s); (2) imposing an upper bound and a lower bound on the number of recipients selected from each segment to receive the new offer(s); (3) imposing a maximum allowed budget for mailing costs of the new offer(s); (4) imposing a maximum allowed budge for discount costs associated with the new offer(s); (5) imposing a lower bound on the ROI for each segment-offer combination; and/or (6) imposing a lower bound on the ROI for the entire set of recipients and offers.

Once the entities objective function (i.e., maximizing incremental sales) and constraints are established, conventional linear programming techniques can be used to determine the best set of segments and offers to use for the new offer(s). For example, a linear programming model or equation set may be based on the following:

Subscripts

Target segments in the population: g=1, . . . , G

Offers: o=1, . . . , O

Raw Parameters/Variables

Total number of recipients in segment g: NM^{g}

More specifically, the NM^{g} variable refers to or represents the number of recipients belong to segments g of the whole recipient population and who are being considered for any of the potential offers.

Mailing cost for offer o: MCₒ (per recipient)

More specifically, the MCₒ variable refers to or represents the cost of a mail piece that is sent to a recipient to invite the recipient to use a specific offer o.

Discount cost on offer o from segment g:

$$Discount cost on offer o from segment g : D {C}_{o}^{g}$$

(per recipient)

More specifically, this variable refers to or represents the cost incurred per recipient in segment g to give recipient the concessions related to offer o.

Total cost on offer o from segment g: TCₒ^{g}=MCₒ+DCₒ^{g} (per recipient)

More specifically, this variable refers to or represents the total cost involved in communicating the offer o to a recipient in segment g and in giving the recipient the concessions related to that offer.

Incremental sales on offer o from segment g: ISₒ^{g} (per recipient)

More specifically, this variable refers to or represents the average incremental sales per recipient on offer o from segment g in the period during which the offer o can be used.

Benefit on offer o from segment g: BFₒ^{g} (per recipient)

More specifically, this variable refers to or represents the average benefit (in dollars) per recipient on offer o from segment g in the period during which the offer o can be used; these are calculated based on the profit margins.

Mailing budget: MB

More specifically, the MB variable refers to or represents the total budget available that can be used to send mail pieces to recipients for various offers.

Discount budget: DB

More specifically, the DB variable refers to or represents the total budget available that can be used to give to recipients the concession benefits associated with various offers.

Maximum number of recipients permitted for offer o: NM^{o}

More specifically, the NM^{o} variable refers to or represents the maximum number of recipients to whom offer o should be communicated.

ROI on offer o from segment g:

$$ROI on offer o from segment g : {ROI}_{o}^{g} = \frac{( {BF}_{o}^{g} - {TC}_{o}^{g} )}{{TC}_{o}^{g}}$$

More specifically, this variable refers to or represents the percent return on investment from offer o and segment g; it is calculated by dividing the net income (total benefit minus total cost) by the total cost.

Threshold minimum ROI for any segment:

$$Threshold minimum ROI for any segment : {ROI}_{min}^{seg}$$

More specifically, the

$${ROI}_{min}^{seg}$$

variable refers to or represents the minimum ROI which is desired from any segment; it means that if any segment g with offer o gives less ROI than the above threshold, i.e.,

$${ROI}_{o}^{g} < {ROI}_{min}^{seg} ,$$

then the segment g should not be given offer o.

Threshold minimum ROI for the whole portfolio of offers and recipients:

$$Threshold minimum ROI for the whole portfolio of offers and recipients : {ROI}_{min}^{folio}$$

More specifically, the

$${ROI}_{min}^{folio}$$

variable refers to or represents the minimum ROI which is desired from the whole marketing campaign; it means that the overall ROI from various offers given to various segments should be equal to or higher than the above value.

Decision Variable

Number of recipients from segment g selected for offer o:

$$Number of recipients from segment g selected for offer o : {n}_{o}^{g}$$

More specifically, the decision variable refers to or represents the number of recipients in segment g who will be given the offer o.

Aggregates for Optimization

Total number selected from segment g for all offers:

$$Total number selected from segment g for all offers : {TN}^{g} = {\sum }_{o = 1}^{O} {n}_{0}^{g}$$

More specifically, this variable refers to or represents the total number of recipients from segment g who will be given any one of the multiple offers.

Total number selected for offer o from all segments:

$$Total number selected for offer o from all segments : {TN}_{o} = {\sum }_{g = 1}^{G} {n}_{o}^{g}$$

More specifically, this variable refers to or represents the total number of recipients who will be given offer o.

Total number selected overall:

$$TNM = {\sum }_{g = 1}^{G} {\sum }_{o = 1}^{O} \cdot {n}_{o}^{g}$$

More specifically, this variable refers to or represents the total number of recipients from all segments who will be given any one of the multiple offers.

Total incremental sales:

$$TIS = {\sum }_{g = 1}^{G} {\sum }_{o = 1}^{O} {IS}_{o}^{g} \cdot {n}_{o}^{g}$$

More specifically, this variable refers to or represents the total incremental sales obtained from all the recipients as a result of their use of credit card in the duration of various offers.

Total benefit:

$$TBF = {\sum }_{g = 1}^{G} {\sum }_{o = 1}^{O} {BF}_{o}^{g} \cdot {n}_{o}^{g}$$

More specifically, this variable refers to or represents the total benefits (in dollars) obtained from all the recipients as a result of their use of credit card in the duration of various offers.

Total mailing cost:

$$TMC = {\sum }_{g = 1}^{G} {\sum }_{o = 1}^{O} {MC}_{o}^{g} \cdot {n}_{0}^{g}$$

More specifically, this variable refers to or represents the total money spent for communicating the various offers all the selected recipients.

Total discount cost:

$$TDC = {\sum }_{g = 1}^{G} {\sum }_{o = 1}^{O} {DC}_{o}^{g} \cdot {n}_{o}^{g}$$

More specifically, this variable refers to or represents the total cost incurred to give concession benefits related to various offers to all the recipients who used those offers.

Total overall cost:

$$TTC = TMC + TDC = {\sum }_{g = 1}^{G} {\sum }_{o = 1}^{O} {TC}_{o}^{g} \cdot {n}_{o}^{g}$$

More specifically, this variable refers to or represents the total cost involved in communicating the various offer to all the selected recipients and in giving them the concessions related to various offers.

$$ROI overall : ROI = \frac{( TBF - TTC )}{TTC} = \frac{( {\sum }_{g = 1}^{G} {\sum }_{o = 1}^{O} {BF}_{o}^{g} \cdot {n}_{o}^{g} - {\sum }_{g = 1}^{G} {\sum }_{o = 1}^{O} {TC}_{o}^{g} \cdot {n}_{o}^{g} )}{{\sum }_{g = 1}^{G} {\sum }_{o = 1}^{O} {TC}_{o}^{g} \cdot {n}_{o}^{g}}$$

More specifically, this variable refers to or represents the overall return on investment from the whole campaign.

Objective Function

Maximize Total Incremental Sales, i.e., max

$$Z = TIS ( = {\sum }_{g = 1}^{G} {\sum }_{o = 1}^{O} {IS}_{o}^{g} \cdot {n}_{o}^{g} )$$

The objective function represents the requirement that the offer(s) selected during the step 104 must comply with or satisfy in light of the constraints imposed by the entity. Example constraints may be established in a mathematical formulation for use in a linear programming analysis as follows.

Constraints

Segment and offer combinations with ROI below threshold should not be considered (for example, if the ROI of segment g on offer o is less than the minimum desired segment ROI

$$( value {ROI}_{min}^{seg} ) ,$$

then that segment should not be given that offer.

$${ROI}_{o}^{g} \geq {ROI}_{min}^{seg}$$

For each segment of recipients, the total number of recipients selected for various offers should be less than or equal to the total number of recipients in that segment:

$${\sum }_{o = 1}^{O} {n}_{o}^{g} \leq N {M}^{g}$$

For each offer, the total number of recipients selected over all the segments should be within the pre-specified limit:

$${\sum }_{g = 1}^{G} {n}_{o}^{g} \leq N {M}^{o}$$

The total cost of mailing of offer(s) to recipients should be within the mailing budget:

$${\sum }_{g = 1}^{G} {\sum }_{o = 1}^{O} M {C}_{o}^{g} \cdot {n}_{o}^{g} \leq M B$$

The total cost of discount should be within the discount budget:

$${\sum }_{g = 1}^{G} {\sum }_{o = 1}^{O} D {C}_{o}^{g} \cdot {n}_{o}^{g} \leq D B$$

The portfolio ROI should be greater than or equal to the minimum desired ROI:

$$\frac{( {\sum }_{g = 1}^{G} {\sum }_{o = 1}^{O} B {F}_{o}^{g} \cdot {n}_{o}^{g} - {\sum }_{g = 1}^{G} {\sum }_{o = 1}^{O} T {C}_{o}^{g} \cdot {n}_{o}^{g} )}{{\sum }_{g = 1}^{G} {\sum }_{o = 1}^{O} T {C}_{o}^{g} \cdot {n}_{o}^{g}} \geq {ROI}_{min}^{folio}$$

which can be linearized as follows

$$( {\sum }_{g = 1}^{G} {\sum }_{o = 1}^{O} B {F}_{o}^{g} \cdot {n}_{o}^{g} - {\sum }_{g = 1}^{G} {\sum }_{o = 1}^{O} T {C}_{o}^{g} \cdot {n}_{o}^{g} ) \geq {ROI}_{min}^{folio} \cdot ( {\sum }_{g = 1}^{G} {\sum }_{o = 1}^{O} T {C}_{o}^{g} \cdot {n}_{o}^{g} )$$

therefore:

$${\sum }_{g = 1}^{G} {\sum }_{o = 1}^{O} [ B {F}_{o}^{g} - ( 1 + {ROI}_{min}^{folio} ) \cdot T {C}_{o}^{g} ] \cdot {n}_{o}^{g} \geq 0$$

Solving the equations above using convention linear programming and other numerical techniques for the recipients and offer data of Table 1 may result in the solutions illustrated in Table 2.

TABLE 2

| | | Number | | | | | | |
|---|---|---|---|---|---|---|---|---|
| | Offer | of Rec. | | | | | | |
| | (either | to be | Total | Total | | Total | | |
| | offer A or | Mailed | Mailing | Discount | Total | Inc. | | |
| Segment | offer B) | the Offer | Cost | Cost | Cost | Sales | ROI | GMR |
| Mortgage | Card | 28,650 | $17,190 | $80,541 | $97,731 | $2,849,844 | 425% | 29 |
| Inquiry | Reissue + | | | | | | | |
| | 10% off | | | | | | | |
| LPD 0-6 | Card | 134,162 | $80,497 | $599,273 | $679,770 | $8,812,759 | 133% | 13 |
| Mth | Reissue + | | | | | | | |
| Medium | 10% off | | | | | | | |
| Inactive | Card | 343,225 | $205,935 | $835,581 | $1,041,516 | $21,187,931 | 266% | 20 |
| | Reissue + | | | | | | | |
| | 10% off | | | | | | | |
| LPD 7-12 | Card | 88,700 | $53,220 | $314,787 | $368,007 | $5,414,683 | 165% | 15 |
| Mth High | Reissue + | | | | | | | |
| | 10% off | | | | | | | |
| LPD 7-12 | Card | 78,300 | $46,980 | $169,817 | $216,797 | $3,786,283 | 214% | 17 |
| Mth | Reissue + | | | | | | | |
| Medium | 10% off | | | | | | | |
| LPD 0-6 | Card | 160,297 | $96,178 | — | $96,178 | $4,898,105 | 817% | 51 |
| Mth High | Reissue | | | | | | | |
| All | | 833,333 | $500,000 | $2,000,000 | $2,500,000 | $46,949,604 | 238% | 19 |

As illustrated in Table 2, 28,650 members of the segment labeled “Mortgage Inquiry” should be mailed Offer B, 134,162 members of the segment labeled “LPD 0-6 Mth Medium” should be mailed Offer B, 343,225 members of the segment labeled “Inactive” should be mailed Offer B, etc. Thus, in this example of the step 104, potential recipients of the new Offers A and B also are identified and multiple offers are being provided. For other business or marketing reasons, some or all of the members may not be provided with the designated offers. In some embodiments, the ROI, GMR and other numerical values and information found in Table 1 and/or Table 2 may be used to score or rank, or to create scores or ranks, for further evaluation and prioritizing of different offer/segment combinations.

As illustrated above, in some embodiments, the step 104 may be or include selecting one offer from a plurality of offers that best complies with a requirement; identifying one or more recipients that should receive one or more offers; selecting at least two offers from a plurality of offers that comply with a requirement when implemented together; creating a score for each of a plurality of offers, an offer's score being indicative of a degree of compliance with a requirement by the offer; ranking each of a plurality of offers according to degree of compliance with a requirement and using at least the best ranked offer for a campaign; scoring each of a plurality of offers according to degree of compliance with a requirement and selecting at least one of the plurality of offers based, at least in part, on the scoring; etc.

In some embodiments, the step 104 or the method 100 may include determining the requirement or other objective. In some embodiments, determining a requirement or objective may be or include receiving a request to conduct a campaign that satisfies the requirement or objective, receiving data from a device or entity indicative of the requirement or objective, using a requirement or objective from a previous campaign, allowing an entity to select from multiple potential requirements or objectives, etc.

During a step 106, the manager or other entity or device determines a plurality of potential recipients of the offer determined during the step 104. In some embodiments, a manager may receive lists or other data indicative of potential recipients from another party (e.g., an advertiser, a promotional campaign organizer) or device. In some embodiments, different groups or segments of potential recipients may be associated with different offers. For example, in some embodiments, potential recipients of an offer may comprise those recipients who have responded to a similar offers in the past or performed a designated action (e.g., created incremental sales) after receiving similar offers in the past. Thus, as different previous offers may have different sets of previous respondents, the potential recipients for the different new offers may vary. In some embodiments, the steps 104 and 106 may be conducted simultaneously or in conjunction, or considered as one step, as illustrated by the examples provided above in regards to Table 1 and Table 2.

As a further example, once an offer is identified during the step 104, a merchant, advertiser or other party associated with the offer regarding a financial product may want to designate or indicate potential recipients of the offer. More specifically, the merchant, advertiser or other party may want to limit the potential recipients to current customers, current users of the financial product, people who are not current customers, people who currently are not users of the financial product, etc.

As another example, using the information illustrated in Table 1 and Table 2 above, once it is determined that 28,650 members of the segment labeled “Mortgage Inquiry” are to receive an offer for a credit card reissue plus ten percent off purchases made using the card, all of the members of the segment can be identified from a recipient or segment information database and provided with the offer. Similarly once it is determined that 134,162 of the 496,250 members of the segment labeled “LPD Mth High Inquiry” are to receive an offer for a credit card reissue plus ten percent off purchases made using the card, 134,162 members of the segment can be randomly selected and provided with the offer.

Additional information regarding potential segmentation or identification of potential recipients associated with one or more offers can be found in the co-pending U.S. patent application entitled Method and Apparatus for Promoting Use of a Financial Product, filed simultaneously herewith and the contents of which are incorporated herein by reference.

During a step 108, the offer(s) determined during the step 104 is(are) provided to at least one of the potential recipients identified during the step 106. The offer(s) may be provided via an automated or human conducted sales or telemarketing call, included in an email message, included in an instant message communication or other electronic signal or communication, included in a letter, flyer, etc., included in a bill or other statement mailed or otherwise sent to the recipient, included in a promotional communication sent to the recipient, etc.

In some embodiments, the method 100 may include receiving a request to conduct a campaign, determining information regarding one or more potential recipients, etc. For example, prior to or as part of the step 102, the manager may receive demographic information, lifestyle information (e.g., hobbies, preferences, spending patterns), credit history information (e.g., number of credit cards, balances of credit cards, payment delinquency, bank or other financial account balances, FICO information), and/or credit performance information (e.g., credit limit on credit card, average or current balance on credit card, transactions made using a credit card, finance charge information) for recipients of one or more prior offers or communications or one or more potential recipients of one or more new offers or communications. Some or all of the information may come from credit bureaus, government agencies, publicly available records, financial product sellers, credit card issuers, or other information sources or providers. In some embodiments, information regarding one or more recipients may be stored in, or access from, a recipient information database.

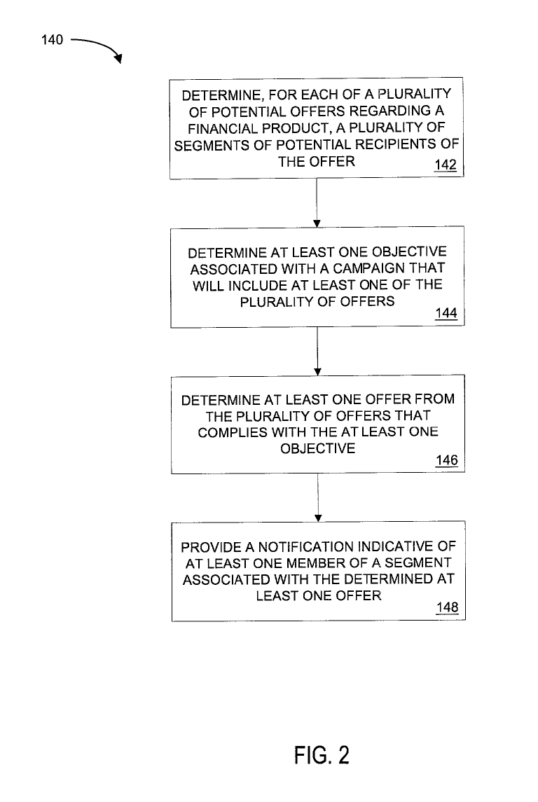

Reference is now made to FIG. 2, where a flow chart 140 is shown which represents the operation of a second embodiment of the present invention. The particular arrangement of elements in the flow chart 140 is not meant to imply a fixed order to the steps; embodiments of the present invention can be practiced in any order that is practicable. In some embodiments, some or all of the steps of the method 140 may be performed or completed by a server, user device and/or another device, as will be discussed in more detail below. For purposes of discussion, but not limitation, of the method 140, the method 140 is assumed to be conducted by a “manager” and/or a “manager device” on behalf of itself and/or one or more other entities. In some embodiments, the method 140 may include some or all of the variations discussed above with regard to the method 100.

Processing begins at a step 142 during which, for each of a plurality of potential offers regarding a financial product, a plurality of segments of potential recipients of the offer is determined. As one example of the step 142, the manager may decide to send a new offer only to those people who have responded positively (e.g., have completed as designated or desired action or behavior) upon receiving a previous offer similar to the new offer. For each of a plurality of new offers that the manager is considering during the step 142, the manager may make a list of recipients of previous offers similar to the new offers. The manager may segment each list into groups depending on various criteria. For example, the manager may make an offer to recipients on the list associated with the offer in different formats depending on the age, gender, location, income level or other demographic characteristic. Different formats of the same offer may be associated with different groups from the segmented list of recipients associated with the offer.

Another technique of determining segments of potential recipients for an offer that may be used during the step 142 is to determine significant variables for different segments of recipients of prior offers or communications and generate a score for the potential recipients of a new offer or communication indicative of response rates for the new offer or communication based on these variables. For example, prior to or as part of the step 142, the manager may receive demographic information, lifestyle information (e.g., hobbies, preferences, spending patterns), credit history information (e.g., number of credit cards, balances of credit cards, payment delinquency, bank or other financial account balances, FICO information), and/or credit performance information (e.g., credit limit on credit card, average or current balance on credit card, transactions made using a credit card, finance charge information) for recipients of one or more prior offers or communications. Some or all of the information may come from credit bureaus, government agencies, publicly available records, financial product sellers, credit card issuers, or other information sources or providers.

The manager may use the information in a logistic regression analysis, swap set analysis, linear programming analysis, multivariate analysis, or other data or numerical analysis to determine the most significant variables that predict a recipient's likely response to a new offer or communication. For example, suppose the financial product involved in an offer or communication is a credit card. The offer or communication is sent to current possessors or users of the credit card in hopes of motivating the recipients to increase their use of the credit card to make purchases over what they would have done normally (i.e., what they would have done if they had not received the offer or communication). For example, the offer or communication may have offered ten percent off all purchases made using the credit card at a specific merchant (e.g., JC Penny, Walmart, Macys). The credit card even may be branded or private labeled with the merchant's name. Thus, the desired action for a recipient receiving the offer or communication is an incremental use of the credit card by the recipients over the recipient's normal use. It may be determined via trial and error, the analysis of responses to earlier communications, numerical modeling, etc. that predicting a recipient's likelihood of response to a new offer or communication may be found by looking at the five following predictor variables: TNUM, the number of transactions the recipient has made in the last three months using the credit card; UTIL, the current utilization of the credit card (e.g., the current balance of the credit card divided by the maximum allowed balance of the credit card); PB24 the number of months in the past twenty-four months where the recipient has a positive balance on the credit card or has used the credit card to make a purchase; MSLS, the number of months since the credit card was used to make a purchase; and AVGBAL, the average daily balance for the credit card in the past month.

A first score S1 for this offer may be generated based on the five predictor variables as follows: S1=((AVGBAL×0.000243)+(UTIL×0.08858)−(MSLS×0.2448)+(PB24×0.0521+(TNUM×0.0929)−4.5346). A final score SF for the offer may be generated as follows: SF=e^{S1}/(1+e^{S1}). The number “−4.5346” may act as a sort of bias or intercept for computing the final score for this offer.

During the step 102, the manager may generate a score for each potential recipient of a new offer or communication. Segments of recipients can be created by grouping the recipients according to their score. Thus, each segment has an indicative characteristic that is a score or score range. For example, suppose scores for 47,566 recipients of one or more prior communications containing an offer regarding a credit card are computed using the formulas for S1 and SF described above. Some of the recipients had the desired response to the communication (e.g., incremental purchases with their credit cards) while others did not. Ten segments for the recipients may be generated by using the scores and breaking or segmenting the recipients into deciles, as illustrated in Table 3.

TABLE 3

| | Cumulative | Minimum | Maximum | |
|---|---|---|---|---|
| | Number of | Score for | Score for | Response |
| Decile | Recipients | SF | SF | Rate |
| 1 | 4,756 | 0.103 | 0.977 | 16.2% |
| 2 | 9,513 | 0.067 | 0.102 | 8.3% |
| 3 | 14,269 | 0.044 | 0.066 | 5.5% |
| 4 | 19,026 | 0.029 | 0.043 | 3.6% |
| 5 | 23,783 | 0.019 | 0.028 | 2.3% |
| 6 | 28,539 | 0.012 | 0.018 | 1.5% |
| 7 | 33,296 | 0.007 | 0.011 | 1.0% |
| 8 | 38,052 | 0.003 | 0.006 | 0.5% |
| 9 | 42,809 | 0.001 | 0.002 | 0.2% |
| 10 | 47,566 | | <0.001 | 0.1% |

Once potential recipients are broken into the ten segments based on deciles, the predicted response rates for the segments to a new offer or communication can be determined by looking at the responses of the recipients in the segments that received prior offer(s) or communication(s). In some cases, a member of a segment may not have received a prior offer or communication or may not have received the same number of offers or communications as another member of the segment. Thus, a potential recipient may be in segment 1 and be associated with the offer, for example, even though the potential recipient never received a prior offer or communication.

Each segment illustrated in Table 3 has at least one indicative characteristic, namely, the SF score ranges associated with the segment and/or the response rate associated with the segment. Other indicative characteristics (e.g., demographic similarities) among members of a specific segment also may be determined.

Different offers may result in different segmentations of recipients and different associations between different offers and potential recipients of the offers.

Additional information and examples regarding potential segmentation or identification of potential recipients for one or more offers can be found in the co-pending U.S. patent application entitled Method and Apparatus for Promoting Use of a Financial Product, filed simultaneously herewith and the contents of which are incorporated herein by reference.

During a step 144, at least one requirement or other objective associated with a campaign that will include one of the offers involved in the step 142 is determined. For example, an entity conducting or requesting a promotional campaign may want promotional communications or campaigns containing the identified offer to be mailed to a maximum number of recipients, to be mailed to a maximum percentage of all of the potential recipients, etc. As another potential requirement, the entity may have a maximum amount the entity can spend on the campaign. As another example, the entity may want to receive a minimum or lower threshold number of respondents to an offer (e.g., recipients who complete a designated action associated with the campaign after receiving the offer) for the least cost, a minimum number or lower threshold number of respondents to an offer as a percentage of all recipients of the offer, etc. As a further example, the entity may establish a minimum return on investment (ROI), a minimum gross marketing return (GMR), maximum risk, a minimum propensity of response, a maximum number of recipients of a communication containing the offer, a minimum incremental sales result, etc. that the offer determined during the step 104 preferably will meet, provide or satisfy (i.e., comply with).

In some embodiments, the step 144 may be or include determining a requirement that the campaign have a minimum number of respondents to an offer; determining a requirement that at least a minimum number of recipients of one of the plurality of offers complete the designated action; determining a requirement that the campaign have not greater than a designated cost; determining a requirement that the campaign have a maximum number of recipients; receiving data indicative of the at least one objective; and receiving data (e.g., link, URL) indicative of a location where information regarding the at least one objective can be found.

During a step 146, at least one of the offers involved in the step 142 is selected that best meets, satisfies or otherwise complies with the objective determined during the step 144 is determined. In some embodiments, more than one offer may be identified or selected during the step 146. The step 146 is similar to the step 106 previously discussed above. In some embodiments, the step 146 may be or include selecting one or more offers from the plurality of offers that best complies with the at least one objective; selecting at least two offers from the plurality of offers that comply with the at least one objective when implemented together; creating a score for each of the plurality of offers, an offer's score being indicative of a degree of compliance with the at least one objective by the offer; ranking each of the plurality of offers according to degree of compliance with the at least one objective and using at least the best ranked offer for the campaign; scoring each of the plurality of offers according to degree of compliance with the at least one objective and selecting at least one of the plurality of offers based, at least in part, on the scoring; etc. In some embodiments, the step 146 may include determining one or more potential recipients of the offer(s) determined during the step 146.

During a step 148, a notification is provided regarding at least one member of the plurality of recipients associated with the offer(s) determined during the step 146. For example, a manager implementing the method 140 on behalf of an advertiser may supply information regarding the offer identified during the step 146 and one or more recipients associated with the offer. The advertiser may then send a promotional communication regarding the offer to the identified recipient(s). In other embodiments, the manager itself may provide the promotional communication directly to the recipients.

In some embodiments, the notification may comprise, be sent in, or be part of an email message, instant message communication, banner or other electronic or Web based advertisement, letter, postcard, flyer, document, paper, coupon, facsimile transmission, beeper or pager signal or transmission, HTTP, FTP, XML or HTML transmission or feed, some other electronic signal or communication, etc. Alternatively, the notification may comprise or be part of the offer made to a recipient, the offer being the offer determined during the step 146.

In some embodiments, the step 148 or the method 140 may include providing the offer determined during the step 146 to at least one member of at least one segment of potential recipients associated with the offer; and providing a communication that includes a list of identified recipients of the determined offer.

In some embodiments, the method 140 may include determining a designated action associated with at least one segment. In some embodiments, designated actions associated with some offers or segments may be the same as, or different from, designated actions associated with other offers or segments.

In some embodiments, the method 140 may include receiving a request to conduct a promotional campaign; determining use of a financial product by a recipient of an offer; determining incremental use of a financial product by a recipient of an offer regarding the financial product, determining at least one of the plurality of offers involved in the step 142; etc.

Other variations and embodiments of the methods disclosed above are also possible. For example, in some embodiments, a method for selecting an offer regarding a financial product to provide to a recipient may include determining a first plurality of segments of potential recipients of a first offer, wherein each of the first plurality of segments has an associated response rate, and wherein a segment's associated response rate is indicative of a member of the segment completing a designated action associated with the segment after receiving the first offer; determining a second plurality of segments of potential recipients of a second offer, wherein each of the second plurality of segments has an associated response rate, and wherein a segment's associated response rate is indicative of a member of the segment completing a designated action associated with the segment after receiving the second offer; determining at least one objective associated with a campaign regarding the financial product; and providing either the first offer to at least one member of at least one segment from the first plurality of segments if the first offer meets the at least one objective better than the second offer, or the second offer to at least one member of at least one segment from the second plurality of segments if the second offer meets the at least one objective better than the first offer. In some embodiments, the method may include some or all of the variations discussed above.

In some embodiments, a method for determining an offer regarding a financial product to provide to a recipient may include determining a plurality of potential offers for a campaign regarding a financial product, the campaign having at least one associated requirement and at least one designated action; determining, for each offer from the plurality of potential offers, a plurality of segments of potential recipients of the offer, wherein each segment from the plurality of segments has an associated characteristic, the characteristic being indicative of a member of the segment completing the designated action after receiving the offer; determining which offer from the plurality of offers best complies with the at least one requirement; and providing the determined offer to at least one member of a segment of the plurality of segments associated with the determined offer. In some embodiments, the method may include some or all of the variations discussed above.

In some embodiments, a method for determining an offer regarding a financial product may include determining, for each offer of a plurality of potential offers regarding a financial product, a plurality of segments of potential recipients of the offer, wherein each segment for an offer has an associated response rate indicative of a member of the segment completing a designated action associated with the segment after receiving the offer; determining at least one objective associated with a campaign, wherein the campaign will include at least one of the plurality of potential offers; determining a score for at least one of a the plurality of offers, the score being indicative of the at least one offer compliance with the at least one objective; and providing a notification indicative of the score. In some embodiments, the method may include some or all of the variations discussed above.

System

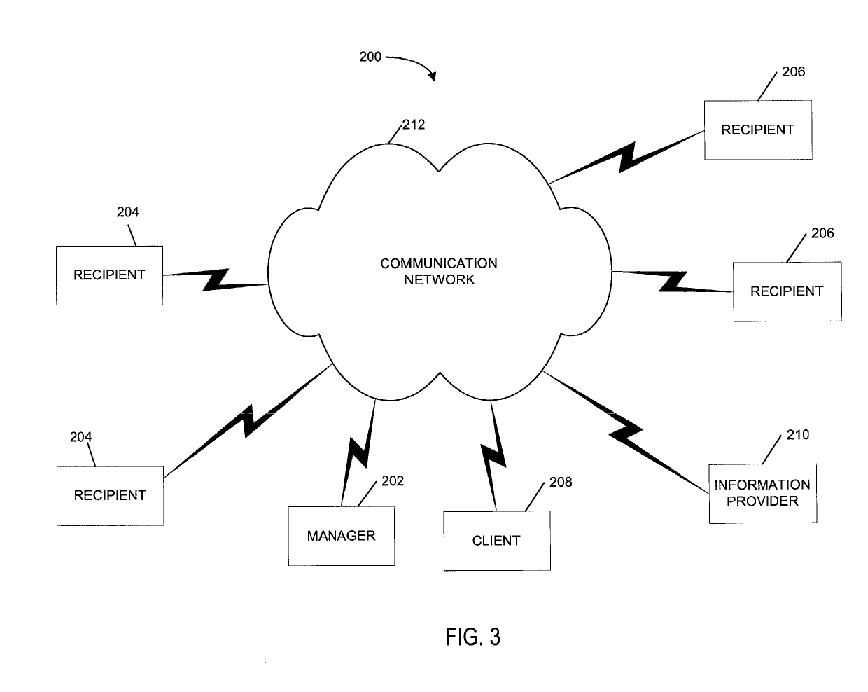

Now referring to FIG. 3, an apparatus or system 200 usable with the methods disclosed herein is illustrated. The apparatus 200 includes a manager or manager device 202 that may communicate directly or indirectly with one or more recipients 204, 206, clients 208, and information providers 210 via a computer, data, or other communications network 212. For purposes of further explanation and elaboration of the methods disclosed herein, the methods disclosed herein will be assumed to be operating on, or under the control of, the manager or manager device 202.

In some embodiments, the manager or manager device 202 may implement one or more of the methods disclosed herein on behalf of one or more clients 208, which may be an advertiser, company desiring a promotional mailing, etc. In some embodiments, the manager or manager device may issue credit cards or sell other financial products or manage the sale and operation of the financial products for a client 208.

In some embodiments, a manager or manager device 202 may receive information regarding accounts, recipients, offers, communications, etc. from an information provider. For example, the information provider 210 may be or include a credit bureau, government agency, merchant, credit card issuer, financial product seller, credit or transaction settlement company, bank, etc. that may supply information for use with the methods disclosed herein.

A manager device 202 may implement or host a Web site. A manager device 202 can comprise a single device or computer, a networked set or group of devices or computers, a workstation, etc. The use, configuration and operation of servers will be discussed in more detail below.

The recipient or client devices 204, 206 preferably allow entities to interact with the manager device 202 and the remainder of the apparatus 200. The recipient devices 204, 206 also may enable a user to access Web sites, software, databases, etc. If desired, the recipient devices 204, 206 also may be connected to or otherwise in communication with other devices. Possible recipient devices include a personal computer, portable computer, mobile or fixed user station, workstation, network terminal or server, cellular telephone, kiosk, dumb terminal, personal digital assistant, etc. Recipients may receive communications via recipient devices from the manager 202, the client 208, etc.

Many different types of implementations or hardware configurations can be used in the system 200 and with the methods disclosed herein and the methods disclosed herein are not limited to any specific hardware configuration for the system 200 or any of its components.

The communications network 212 might be or include the Internet, the World Wide Web, or some other public or private computer, cable, telephone, client/server, peer-to-peer, or communications network or intranet, as will be described in further detail below. The communications network 212 illustrated in FIG. 3 is meant only to be generally representative of cable, computer, radio, telephone, peer-to-peer or other communication networks for purposes of elaboration and explanation of the present invention and other devices, networks, etc. may be connected to the communications network 212 without departing from the scope of the present invention. The communications network 212 also can include other public and/or private wide area networks, local area networks, wireless networks, data communication networks or connections, intranets, routers, satellite links, microwave links, cellular or telephone networks, radio links, fiber optic transmission lines, ISDN lines, T1 lines, DSL, etc. In some embodiments, a user device may be connected directly to a manager device 202 without departing from the scope of the present invention. Moreover, as used herein, communications include those enabled by wired or wireless technology.

The devices shown in FIG. 3 need not be in constant communication. For example, the manager device 202 may communicate with a recipient device only when such communication is appropriate or necessary.

Manager Device

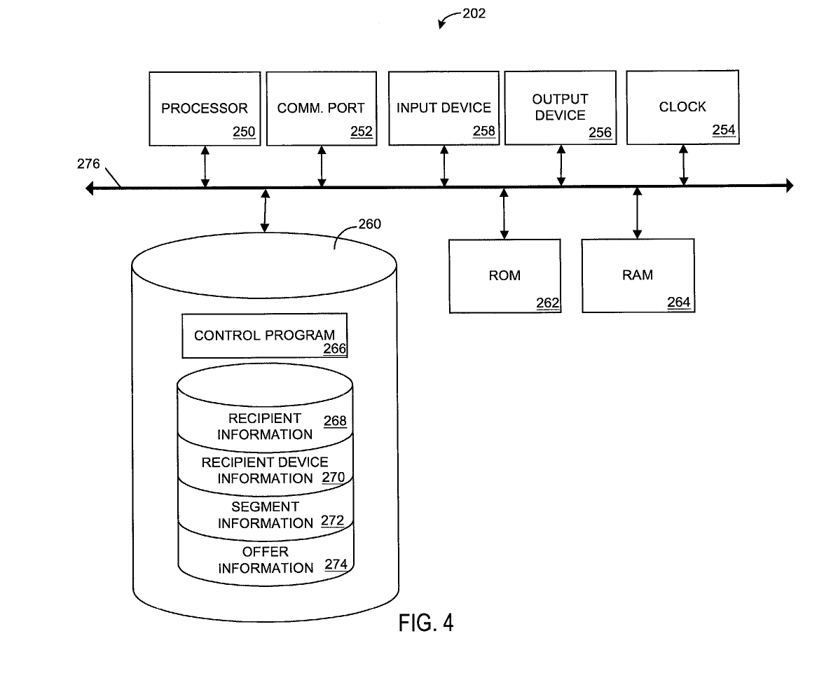

Now referring to FIG. 4, a representative block diagram of a manager device (also referred to as a server or controller 204) is illustrated. The manager device 202 may include a processor, microchip, central processing unit, or computer 250 that is in communication with or otherwise uses or includes one or more communication ports 252 for communicating with user devices and/or other devices. Communication ports may include such things as local area network adapters, wireless communication devices, Bluetooth technology, etc. The manager device 202 also may include an internal clock element 254 to maintain an accurate time and date for the manager device 202, create time stamps for communications received or sent by the manager device 202, etc.

If desired, the manager device 202 may include one or more output devices 256 such as a printer, infrared or other transmitter, antenna, audio speaker, display screen or monitor, text to speech converter, etc., as well as one or more input devices 258 such as a bar code reader or other optical scanner, infrared or other receiver, antenna, magnetic stripe reader, image scanner, roller ball, touch pad, joystick, touch screen, microphone, computer keyboard, computer mouse, etc.

In addition to the above, the manager device 202 may include a memory or data storage device 260 to store information, software, databases, communications, device drivers, etc. The memory or data storage device 260 preferably comprises an appropriate combination of magnetic, optical and/or semiconductor memory, and may include, for example, Random Read-Only Memory (ROM), Random Access Memory (RAM), a tape drive, flash memory, a floppy disk drive, a Zip™ disk drive, a compact disc and/or a hard disk. The manager device 202 also may include separate ROM 262 and RAM 264.

The processor 250 and the data storage device 260 in the manager device 202 each may be, for example: (i) located entirely within a single computer or other computing device; or (ii) connected to each other by a remote communication medium, such as a serial port cable, telephone line or radio frequency transceiver. In one embodiment, the manager device 202 may comprise one or more computers that are connected to a remote server computer for maintaining databases. A conventional personal computer or workstation with sufficient memory and processing capability may be used as the manager device 202. In one embodiment, the manager device 202 operates as or includes a Web server for an Internet environment. The manager device 202 preferably is capable of high volume transaction processing, performing a significant number of mathematical calculations in processing communications and database searches. A Pentium™ microprocessor such as the Pentium III™ microprocessor, manufactured by Intel Corporation may be used for the processor 250. Equivalent processors are available from Motorola, Inc., AMD, or Sun Microsystems, Inc. The processor 250 also may comprise one or more microprocessors, computers, computer systems, etc.

Software may be resident and operating or operational on the manager device 202. The software may be stored on the data storage device 260 and may include a control program 266 for operating the server, databases, etc. The control program 266 may control the processor 250. The processor 250 preferably performs instructions of the control program 266, and thereby operates in accordance with the present invention, and particularly in accordance with the methods described in detail herein. The control program 266 may be stored in a compressed, uncompiled and/or encrypted format. The control program 266 furthermore includes program elements that may be necessary, such as an operating system, a database management system and device drivers for allowing the processor 250 to interface with peripheral devices, databases, etc. Appropriate program elements are known to those skilled in the art, and need not be described in detail herein.

The manager device 202 also may include or store information regarding recipients, communications, information providers, clients, financial products, accounts, segments, recipient devices, etc. For example, information regarding one or more recipients may be stored in a recipient information database 268 for use by the manager device 202 or another device or entity, information regarding one or more recipient devices may be stored in a recipient device information database 270 for use by the manager device 202 or another device or entity, information regarding one or more segments may be stored in a segment information database 272 for use by the manager device 202 or another device or entity, information regarding one or more offers may be stored in a communication information database 274, information regarding one or more financial products may be stored in a financial product information database (not shown), information regarding one or more accounts may be stored in an account information database (not shown), information regarding one or more communications may be stored in a communication product information database (not shown), etc. In some embodiments, some or all of one or more of the databases may be stored or mirrored locally and/or remotely from the manager device 202.

According to an embodiment of the present invention, the instructions of the control program may be read into a main memory from another computer-readable medium, such as from the ROM 262 to the RAM 264. Execution of sequences of the instructions in the control program causes the processor 250 to perform the process steps described herein. In alternative embodiments, hard-wired circuitry may be used in place of, or in combination with, software instructions for implementation of some or all of the methods of the present invention. Thus, embodiments of the present invention are not limited to any specific combination of hardware and software.

The processor 250, communication port 252, clock 254, output device 256, input device 258, data storage device 260, ROM 262, and RAM 264 may communicate or be connected directly or indirectly in a variety of ways. For example, the processor 250, communication port 252, clock 254, output device 256, input device 258, data storage device 260, ROM 262, and RAM 264 may be connected via a bus 276.

While specific implementations and hardware configurations for a communication manager device 202 have been illustrated, it should be noted that other implementations and hardware configurations are possible and that no specific implementation or hardware configuration is needed. Thus, not all of the components illustrated in FIG. 4 may be needed for a device implementing the methods disclosed herein. Therefore, many different types of implementations or hardware configurations can be used in the system 200 and the methods disclosed herein are not limited to any specific hardware configuration.

Recipient Device

As mentioned above, a recipient device 204, 206 may be or include any of a number of different types of devices, including, but not limited to a personal computer, portable computer, mobile or fixed user station, workstation, network terminal or server, telephone, beeper, kiosk, dumb terminal, personal digital assistant, facsimile machine, two-way pager, radio, cable set-top box, etc. In some embodiments, a recipient device 204, 206 may have the same structure or configuration as the manager device 202 illustrated in FIG. 4 and include some or all of the components of the manager device 202.

Databases

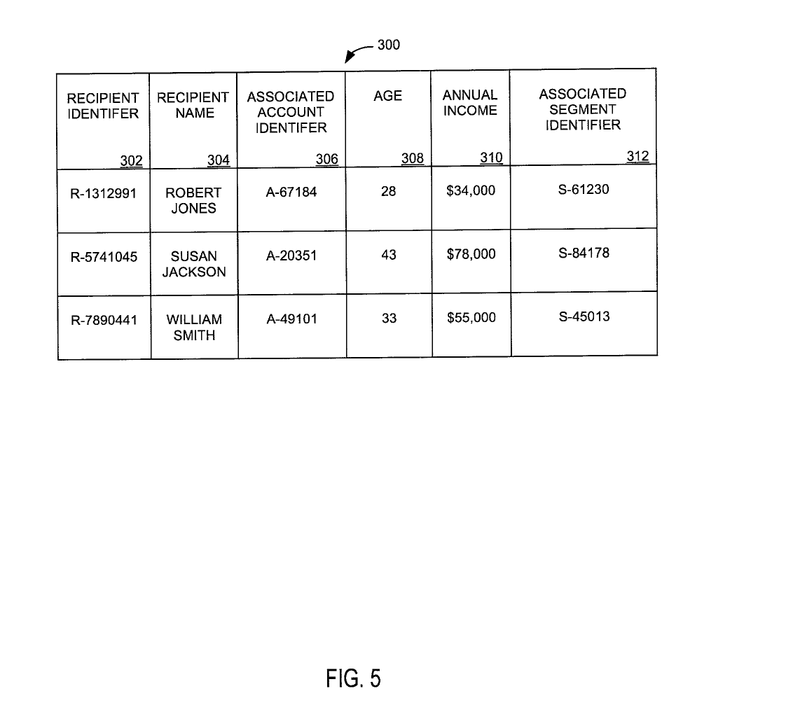

As previously discussed above, in some embodiments the manager device 202, a recipient device, or other device or entity may include or access a recipient information database for storing or keeping information regarding one or more recipient. One representative recipient information database 300 is illustrated in FIG. 5.

The recipient information database 300 may include a recipient identifier field 302 that may include codes or other identifiers for one or more recipient, a recipient name field 304 that may includes names or other information associated with the recipients identified in the field 302, an associated account identifier field 306 that may include codes or other identifiers of accounts associated with the recipients identified in the field 302, an age field 308 that may include age information for the recipients identified in the field 302, an annual income field 310 that may include information regarding the annual incomes of the recipients identified in the field 302, and an associated segment identifier field 312 that may include codes or other identifiers for segments associated with the recipients identified in the field 302.

Other or different fields also may be used in the recipient information database 300. For example, in some embodiments a recipient information database may include contact information, additional or different demographic information (e.g., sex, height, race, nationality, family size, marital status, residence, place of birth), employment information, hobby or preference information, lifestyle information, contact information (e.g., email address, telephone number, postal address), credit history information, spending history information, associated recipient device information, etc. associated with recipients.

As illustrated by the recipient information database 300 of FIG. 5, the recipient identified as “R-1312991” in the field 302 is named “ROBERT JONES” and is twenty-eight years old with an annual income of “$34,000”. The recipient identified as “R-1312991” is associated with the account identified as “A-67184” and the segment identified as “S-61230”.

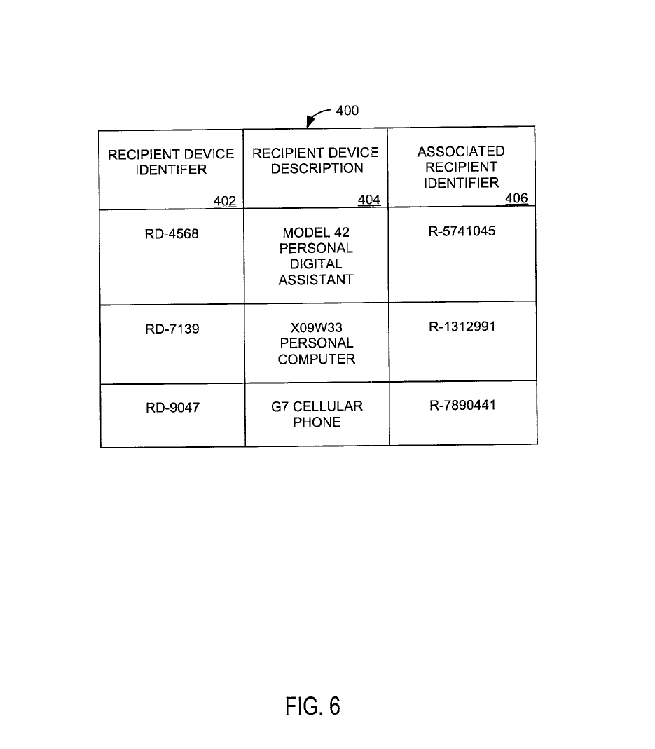

As previously discussed above, in some embodiments the manager device 202, a recipient device or other entity or device may include or access a recipient device information database for storing or keeping information regarding one or more recipient devices. One representative recipient device information database 400 is illustrated in FIG. 6.

The recipient device information database 400 may include a recipient device identifier field 402 that may include codes or other identifiers for one or more recipient devices, a recipient device description field 404 that may include names, model numbers, manufacturer names, etc. for the recipient devices identified in the field 402, and an associated recipient identifier field 406 that may include codes or other identifiers for recipients associated with the recipient devices identified in the field 402.

Other or different fields also may be used in the recipient device information database 400. For example, in some embodiments a recipient device information database may include information regarding performance, configuration, settings, options, costs, training requirements, capabilities, etc. for the recipient devices identified in the field 402.

As illustrated by the recipient device information database 400 of FIG. 6, the recipient device identified as “RD-4568” in the field 402 is a “MODEL 42 PERSONAL DIGITAL ASSISTANT” and is associated with the recipient identified as “R-5741045”.

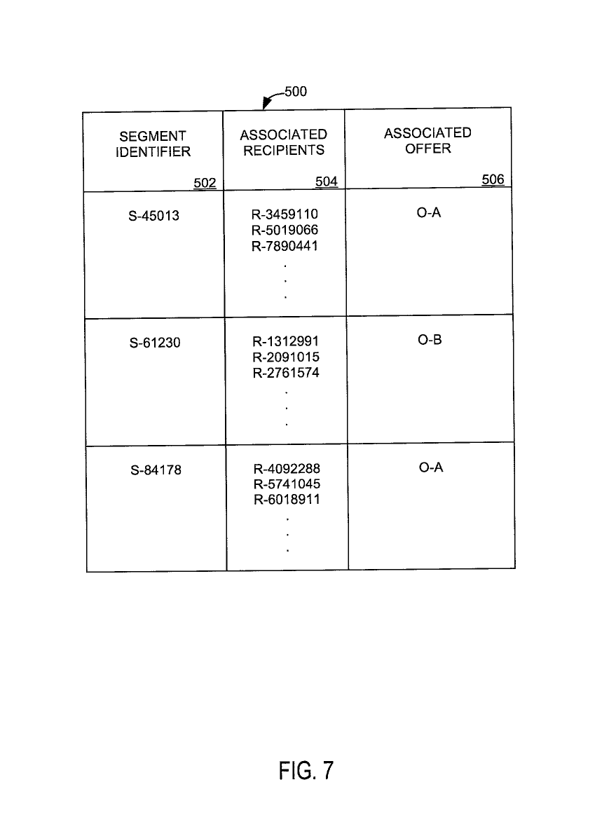

As previously discussed above, in some embodiments a server, user device, or other device may include or access a segment information database for storing or keeping information regarding one or more segments of actual or potential recipients of communications. One representative segment information database 500 is illustrated in FIG. 7.

The segment information database 500 may include a segment identifier field 502 that may include codes or other identifiers for one or more segments, an associated recipients field 504 that may include codes or other identifiers for recipients associated with the segments identified in the field 502, and an offer identifier field 506 that may include codes or other identifiers for offers associated with the segments identified in the field 502.

Other or different fields also may be used in the segment information database 500. For example, in some embodiments a segment information database may include information regarding establishment dates for segments, indicative characteristics for segments, scores associated with segments, etc. For example, some or all of the information illustrated in Table 1 above may be included in a segment information database.

As illustrated by the segment information database 500 of FIG. 7, the segment identified as “S-45013” in the field 502 is associated with the recipients identified as “R-3459110”, “R-5019066”, “R-7890441”, etc. and the offer identified as “O-A”. Note that a recipient may be associated with more than one offer, more than one financial product, and more than one segment. Similarly, a financial product may be associated with more than one offer, and vice versa. For ease of explanation, not all of the recipients identified in the field 504 of the segment information database are listed in the recipient information database 300 of FIG. 5.

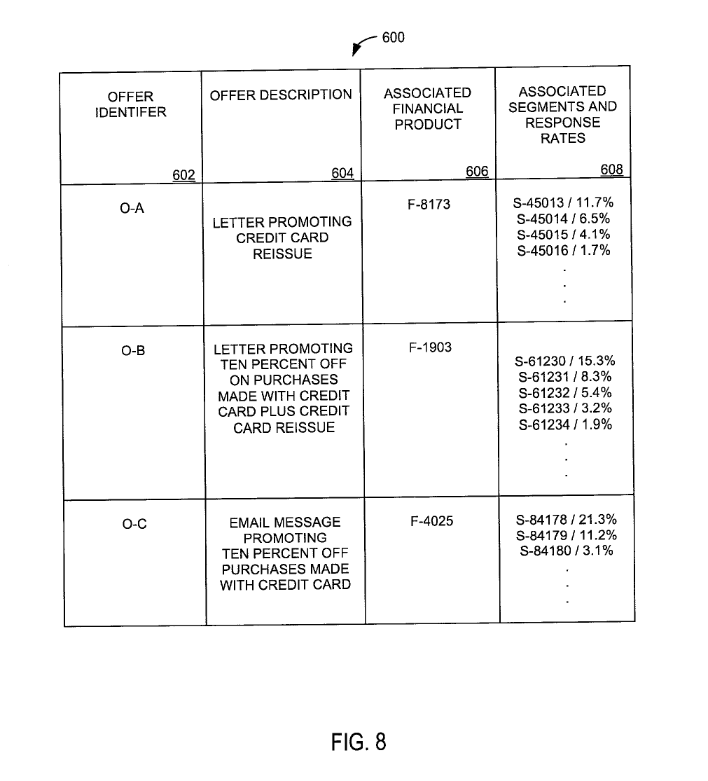

As previously discussed above, in some embodiments the manager device 202, a recipient device, or other entity or device may include or access an offer information database for storing or keeping information regarding one or more offers. One representative offer information database 600 is illustrated in FIG. 8.

The offer information database 600 may include an offer identifier field 602 that may include codes or other identifiers for one or more offers, an offer description field 604 that may include descriptive information regarding the offers identified in the field 602, an associated financial product field 606 that may include codes or other identifiers for one or more financial products associated with the offers identified in the field 602, and an associated segments and response rates field 608 that may includes codes or other identifiers for segments associated with the offers identified in the field 602 and expected or actual response rates for the offers.

Other or different fields also may be used in the offer information database 600. For example, in some embodiments an offer information database may include information regarding advertisers, merchants, clients, etc. associated with the offers, information regarding the size, cost, sophistication, etc. of offers, information regarding the actual or expected time and date that offers were or are to be made, delivery status and/or acceptance status information for the offers, information regarding requirements or objectives associated with the offers, information regarding return on investments (ROIs) associated with different offers and different segments, information regarding gross marketing returns (GMRs) associated with different offers and different segments, information regarding risks associated with different offers and different segments, information regarding recipients for different segments associated with offers, etc. For example, some or all of the information illustrated in Table 1 above may be included in an offer information database.

As illustrated by the offer information database 600 of FIG. 8, the offer identified as “O-B” in the field 602 is a “LETTER PROMOTING TEN PERCENT OFF OF PURCHASES MADE WITH CREDIT CARD” and is associated with the financial product identified as “F-8173”. The offer identified as “O-B” is associated with the segments identified as “S-61230”, “S-61231”, “S-61232”, “S-61233”, “S-61234”, etc. in the field 608. For ease of explanation, not all of the segments identified in the field 608 of the offer information database are listed in the segment information database 500 of FIG. 7.

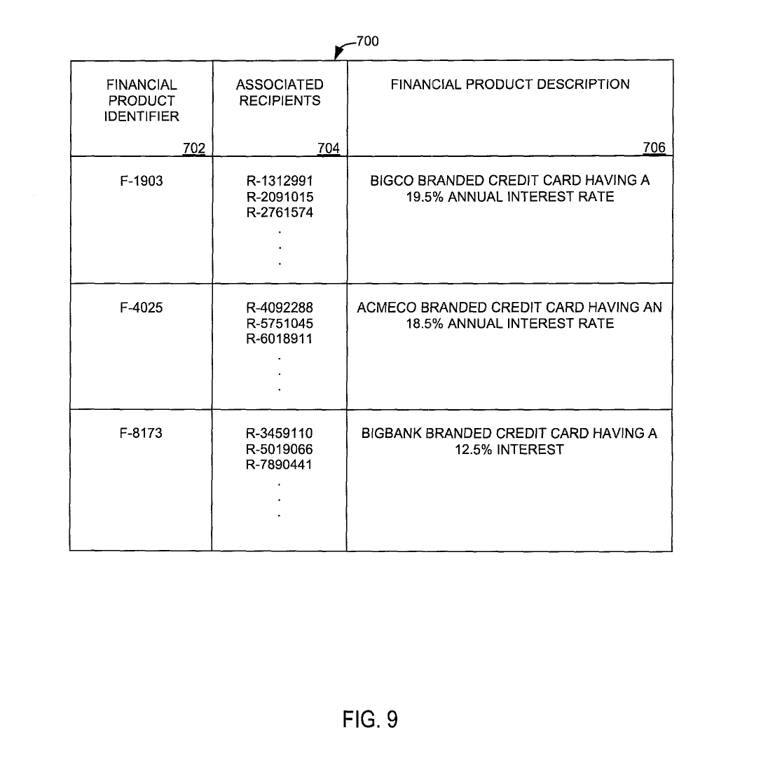

As previously discussed above, in some embodiments the manager device 202, a recipient or other entity or device may include or access a financial product information database for storing or keeping information regarding one or more financial product. One representative financial product information database 700 is illustrated in FIG. 9.

The financial product information database 700 may include a financial product identifier field 702 that may include codes or other identifiers for one or more financial products, an associated recipients field 704 that may include codes or other identifiers of recipients how have or use the financial products identified in the field 702, and a financial product description field 706 that may include descriptive information regarding the financial products identified in the field 702.

Other or different fields also may be used in the financial product information database 700. For example, in some embodiments a financial product information database may include information regarding dates when financial products became available, information regarding numbers of users or purchases of the financial products, information regarding finance charges due or paid finance charges associated with the financial products, information regarding credit line utilizations or average credit line utilizations for the financial products, information regarding lifetime purchases made via the financial products, information regarding frequency of purchases, payments, delinquencies, etc. associated with the financial products, information regarding any special privileges or statuses associated with the financial products, etc.

As illustrated by the financial product information database 700 of FIG. 9, the financial product identified as “F-1903” in the field 702 is used by the recipients identified as “R-1312991”, “R-2091015”, “R-2761574”, etc. and is a “BIGCO BRANDED CREDIT CARD HAVING A 19.5% ANNUAL INTEREST RATE”. For ease of explanation, not all of the recipients identified in the field 704 of the segment information database are listed in the recipient information database 300 of FIG. 5.

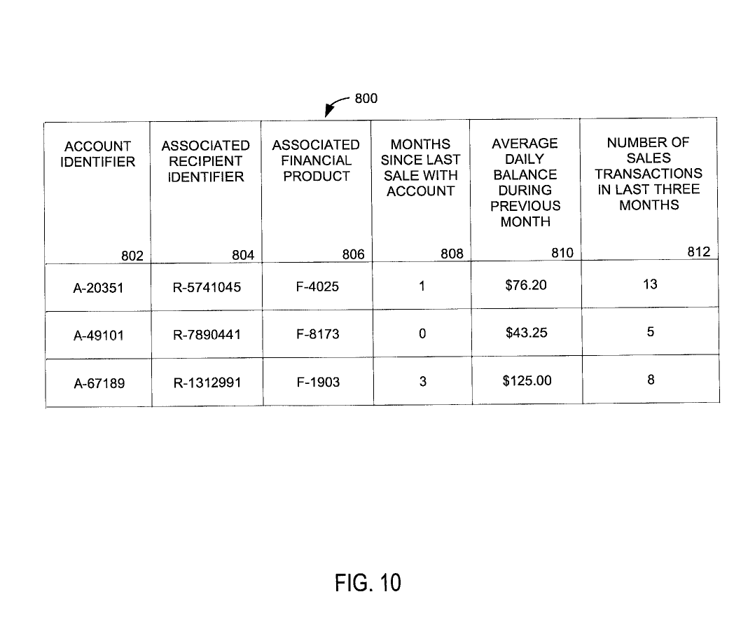

As previously discussed above, in some embodiments a server, user device, or other device may include or access an account information database for storing or keeping information regarding one or more accounts. One representative account information database 800 is illustrated in FIG. 10.

The account information database 800 may include an account identifier field 802 that may include codes or other identifiers for one or more accounts, an associated recipient field 804 that may include codes or other identifiers for recipients associated with the accounts identified in the field 802, an associated financial products field 806 that may include codes or other identifiers for financial products associated with the accounts identified in the field 802, a months since last sale field 808 that may include information regarding the last time the account was used by a recipient to make a purchase, an average daily balance field 810 that may include information regarding the average balance of the accounts identified in the field 802 during a time period (e.g., one month), and a number of sales transactions field 812 that may include information regarding the number of transactions made using the accounts identified in the field 802 during a time period (e.g., three months).

Other or different fields also may be used in the account information database 700. For example, in some embodiments an account information database may include information the number of months accounts have had positive balances, a information regarding payments made by recipients to accounts, information regarding the time, place and goods or services for transactions associated with the accounts, information regarding finance charges due or paid finance charges associated with the accounts, information regarding credit line utilizations or average credit line utilizations for the accounts, information regarding lifetime purchases made via financial products associated with the accounts, information regarding payments made to the accounts, information regarding frequency of purchases, payments, delinquencies, etc. associated with the accounts, information regarding any special privileges or statuses associated with the accounts, etc.

As illustrated by the account information database 800 of FIG. 10, the account identified as “A-20351” in the field 802 is associated with the recipient identified as “R-5741045” and the financial product identified as “F-4025”. There has been at least one month since the last sale using the account “A-20351” and the average daily balance for the account is “$76.20”. There have been thirteen sales transactions during the previous three months using the account “A-20351”.

The methods of the present invention may be embodied as a computer program developed using an object oriented language that allows the modeling of complex systems with modular objects to create abstractions that are representative of real world, physical objects and their interrelationships. However, it would be understood by one of ordinary skill in the art that the invention as described herein could be implemented in many different ways using a wide range of programming techniques as well as general-purpose hardware systems or dedicated controllers. In addition, many, if not all, of the steps for the methods described above are optional or can be combined or performed in one or more alternative orders or sequences without departing from the scope of the present invention and the claims should not be construed as being limited to any particular order or sequence, unless specifically indicated.

Each of the methods described above can be performed on a single computer, computer system, microprocessor, etc. In addition, two or more of the steps in each of the methods described above could be performed on two or more different computers, computer systems, microprocessors, etc., some or all of which may be locally or remotely configured. The methods can be implemented in any sort or implementation of computer software, program, sets of instructions, code, ASIC, or specially designed chips, logic gates, or other hardware structured to directly effect or implement such software, programs, sets of instructions or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, Zip™ disk, flash or optical memory card, microprocessor, solid state memory device, RAM, EPROM, or ROM.

Although the present invention has been described with respect to various embodiments thereof, those skilled in the art will note that various substitutions may be made to those embodiments described herein without departing from the spirit and scope of the present invention.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof.

The embodiments of the invention in which an exclusive property or privilege is claimed are defined as follows:

1. A method for selecting at least one offer regarding a financial product, comprising:
determining a plurality of offers regarding a financial product available for a campaign;
determining at least one of said plurality of offers that complies with a requirement associated with said campaign;
determining a plurality of recipients associated with said determined at least one of said plurality of offers; and
providing said determined at least one of said plurality of offers to at least one of said plurality of recipients.

2. The method of claim 1, wherein said determining a plurality of offers available for a campaign includes at least one of the following: and
receiving data indicative of said plurality of offers; and
receiving a request to use one of a plurality of offers for a campaign; and
receiving information regarding a plurality of recipients of previous offers.

3. The method of claim 1, wherein said determining at least one of said plurality of offers that complies with a requirement associated with said campaign includes at least one of the following:
selecting one offer from said plurality of offers that best complies with said requirement;
selecting at least two offers from said plurality of offers that comply with said requirement when implemented together;
creating a score for each of said plurality of offers, an offer's score being indicative of a degree of compliance with said requirement by said offer;
ranking each of said plurality of offers according to degree of compliance with said requirement and using at least the best ranked offer for said campaign; and
scoring each of said plurality of offers according to degree of compliance with said requirement and selecting at least one of said plurality of offers based, at least in part, on said scoring.

4. The method of claim 1, wherein said determining a plurality of recipients associated with said determined at least one of said plurality of offers includes at least one of the following:
receiving data indicative of said plurality of recipients; and
receiving data indicative of a plurality of segments of recipients, wherein each of said plurality of segments is associated with at least one of said plurality of offers.

5. The method of claim 1, wherein said providing said determined at least one of said plurality of offers to at least one of said plurality of recipients includes at least one of the following:
providing said determined at least one of said plurality of offers via an email message;
providing said determined at least one of said plurality of offers via an instant message communication;
conveying said determined at least one of said plurality of offers via a letter; and
conveying said determined at least one of said plurality of offers via an electronic signal.

6. The method of claim 1, further comprising:
determining said requirement.

7. The method of claim 1, wherein said requirement includes at least one of the following:
a requirement that said campaign have a minimum recipient pool size;
a requirement that said campaign have a maximum recipient pool size;
a requirement that said campaign have a minimum number of respondents to an offer;
a requirement that at least a minimum number of recipients of one of said plurality of offers complete said designated action;
a requirement that said campaign have not greater than a designated cost; and
a requirement that said campaign have a maximum number of recipients.

8. The method of claim 1, wherein said determined at least one of said plurality of offers includes at least one of the following:
an offer for a discount on purchases made using said financial product;
an offer to receive a reissued credit card;
an offer for a discount on purchases made using said financial product at a specific merchant;
an offer for a discount on purchases made using said financial product during a designated time period.

9. The method of claim 1, wherein said financial product includes at least one of the following:
a credit card; and
a debit card.

10. The method of claim 1, further comprising:
receiving a request to conduct said campaign.

11. The method of claim 1, wherein said determined at least one of said plurality of recipients includes a plurality of segments, each of said plurality of segments including at least one of said plurality of recipients.

12. The method of claim 11, wherein each of said plurality of segments has an associated characteristic indicative of a member of said segment's likelihood of completing a designated action associated with said determined one of said plurality of offers.

13. The method of claim 1, further comprising:
determining information regarding at least one of said potential recipients.

14. The method of claim 13, wherein said determining information regarding at least one of said potential recipients includes at least one of the following:
receiving a list of at list two of said potential recipients;
receiving demographic information regarding at least one of said potential recipients;
receiving credit history information regarding at least one of said potential recipients;
receiving lifestyle information regarding at least one of said potential recipients; and
receiving credit performance information regarding at least one of said potential recipients.

15. A method for selecting at least one offer regarding a financial product to make to a recipient, comprising:
determining, for each offer of a plurality of potential offers regarding a financial product, a plurality of segments of potential recipients of said offer, wherein each segment for an offer has an associated response rate indicative of a member of said segment completing a designated action associated with said segment after receiving said offer;
determining at least one objective associated with a campaign, wherein said campaign will include at least one of said plurality of potential offers;
determining at least one offer from said plurality of offers that complies with said at least one objective; and
providing a notification indicative of at least one member of at least one segment of potential recipients associated with said determined at least one offer.

16. The method of claim 15, wherein said determining, for each offer of a plurality of potential offers regarding a financial product, a plurality of segments of potential recipients of said offer, wherein each segment for an offer has an associated response rate indicative of a member of said segment completing a designated action after receiving said offer, includes at least one of the following:
receiving demographic information regarding at least one of said plurality of potential recipients;
receiving credit history information regarding at least one of said plurality of potential recipients;
receiving lifestyle information regarding at least one of said plurality of potential recipients; and
receiving credit performance information regarding at least one of said plurality of potential recipients.

17. The method of claim 15, wherein said determining, for each offer of a plurality of potential offers regarding a financial product, a plurality of segments of potential recipients of said offer, wherein each segment for an offer has an associated response rate indicative of a member of said segment completing a designated action after receiving said offer, includes at least one of the following:
identifying segments of previous recipients of offers;
determining a score for at least one of said plurality of potential recipients based on designated variables, said score being indicative of said at least one of said plurality of potential recipients completing said designated action; and
determining responses by at least some of said plurality of potential recipients to at least one previous offer regarding said financial product.

18. The method of claim 15, wherein said determining at least one objective associated with a campaign includes at least one of the following:
determining a requirement that said campaign have a minimum number of respondents to an offer;
determining a requirement that at least a minimum number of recipients of one of said plurality of offers complete said designated action;
determining a requirement that said campaign have not greater than a designated cost;
determining a requirement that said campaign have a maximum number of recipients;
receiving data indicative of said at least one objective; and
receiving data indicative of a location where information regarding said at least one objective can be found.

19. The method of claim 15, wherein said determining at least one offer from said plurality of offers that complies with said at least one objective includes at least one of the following:
selecting at least one offer from said plurality of offers that best complies with said at least one objective;
selecting at least two offers from said plurality of offers that comply with said at least one objective when implemented together;
creating a score for each of said plurality of offers, an offer's score being indicative of a degree of compliance with said at least one objective by said offer;
ranking each of said plurality of offers according to degree of compliance with said at least one objective and using at least the best ranked offer for said campaign; and
scoring each of said plurality of offers according to degree of compliance with said at least one objective and selecting at least one of said plurality of offers based, at least in part, on said scoring.

20. The method of claim 15, providing at notification indicative of at least one member of at least one segment of potential recipients associated with said determined at least one offer includes at least one of the following:
providing said determined offer to at least one member of at least one segment of potential recipients associated with said determined offer; and
providing a communication that includes a list of identified recipients of said determined offer.

21. The method of claim 15, further comprising:
providing said determined offer to at least one member of at least one segment of potential recipients associated with said determined at least one offer.

22. The method of claim 15, wherein said notification includes at least one of the following:
an email message;
an instant message communication;
an electronic signal;
a letter; and
a message sent to a postal address.

23. The method of claim 15, wherein a designated action associated with a segment may include at least one of the following:
use of said financial product;
incremental use of said financial product;
purchase of a product with said financial product;
signing up for a credit card;
agreeing to accept a credit card;
using a credit card.

24. The method of claim 15, further comprising:
determining a designated action associated with at least one segment.

25. The method of claim 15, wherein a designated action associated with a first segment from a first plurality of segments is different than a designated action for a second segment from said first plurality of segments.

26. The method of claim 15, further comprising:
receiving a request to conduct said campaign.

27. The method of claim 15, further comprising:
determining use of said financial product by a recipient of said determined at least one offer.

28. The method of claim 15, further comprising:
determining incremental use of said financial product by a recipient of said determined offer.

29. The method of claim 15, further comprising:
determining at least one of said plurality of offers.

30. A method for selecting at least one offer regarding a financial product to provide to a recipient, comprising:
determining a first plurality of segments of potential recipients of a first offer, wherein each of said first plurality of segments has an associated response rate, and wherein a segment's associated response rate is indicative of a member of said segment completing a designated action associated with said segment after receiving said first offer;
determining a second plurality of segments of potential recipients of a second offer, wherein each of said second plurality of segments has an associated response rate, and wherein a segment's associated response rate is indicative of a member of said segment completing a designated action associated with said segment after receiving said second offer;
determining at least one objective associated with a campaign regarding said financial product; and
providing either said first offer to at least one member of at least one segment from said first plurality of segments if said first offer meets said at least one objective better than said second offer, or said second offer to at least one member of at least one segment from said second plurality of segments if said second offer meets said at least one objective better than said first offer.

31. The method of claim 30, wherein a designated action associated with a first segment from said first plurality of segments is different than a designated action for a second segment from said first plurality of segments.

32. The method of claim 30, further comprising:
determining said first offer.

33. The method of claim 30, further comprising:
determining if said first offer complies with said at least one objective better than said second offer.

34. A method for determining an offer regarding a financial product to provide to a recipient, comprising:
determining a plurality of potential offers for a campaign regarding a financial product, said campaign having at least one associated requirement and at least one designated action;
determining, for each offer from said plurality of potential offers, a plurality of segments of potential recipients of said offer, wherein each segment from said plurality of segments has an associated characteristic, said characteristic being indicative of a member of said segment completing said designated action after receiving said offer;
determining which offer from said plurality of offers best complies with said at least one requirement; and
providing said determined offer to at least one member of a segment of the plurality of segments associated with said determined offer.

35. A method for determining an offer regarding a financial product, comprising:
determining, for each offer of a plurality of potential offers regarding a financial product, a plurality of segments of potential recipients of said offer, wherein each segment for an offer has an associated response rate indicative of a member of said segment completing a designated action associated with said segment after receiving said offer;
determining at least one objective associated with a campaign, wherein said campaign will include at least one of said plurality of potential offers;
determining a score for at least one of a said plurality of offers, said score being indicative of said at least one offer's compliance with said at least one objective; and
providing a notification indicative of said score.

36. A system for determining an offer regarding a financial product, comprising:
a memory;
a communication port; and
a processor connected to said memory and said communication port, said processor being operative to:
determine a plurality of offers regarding a financial product available for a campaign;
determine one of said plurality of offers that complies with a requirement associated with said campaign;
determine a plurality of recipients associated with said determined one of said plurality of offers; and
provide said determined one of said plurality of offers to at least one of said plurality of recipients.

37. A computer program product in a computer readable medium for determining an offer regarding a financial product, comprising:
first instructions for identifying a plurality of offers regarding a financial product available for a campaign;
second instructions for identifying one of said plurality of offers that complies with a requirement associated with said campaign;
third instructions for identifying a plurality of recipients associated with said determined one of said plurality of offers; and
fourth instructions for sending a communication regarding said determined one of said plurality of offers to at least one of said plurality of recipients.
